(19) United States
(12) Patent Application Publication
(10) Pub. No.: US 2026/0050459 A1
(43) Pub. Date: Feb. 19, 2026

(54) GEOFENCED AI LANDMARK INFORMATION SYSTEM

(71) Applicant: Snap Inc., Santa Monica, CA (US)

(72) Inventor: Suraya Shivji, New York, NY (US)

(21) Appl. No.: 19/298,558

(22) Filed: Aug. 13, 2025

Related U.S. Application Data
(60) Provisional application No. 63/682,564, filed on Aug. 13, 2024.

(51) Int. Cl. G06F 9/451

(52) U.S. Cl. CPC G06F 9/453

(57) ABSTRACT

A method is provided for delivering location-based information using artificial intelligence. The method includes automatically inferring a location of a user system at a geographic landmark based on location data, and triggering an AI assistant in response to the inferred location. The AI assistant generates information about the geographic landmark, and a graphical indication of the AI-generated information is displayed proximate to a graphical representation of the user on a map interface. Upon user selection of the graphical indication, a chat conversation with the AI assistant is initiated, the conversation including the AI-generated information about the geographic landmark

### CLAIM OF PRIORITY

This application claims the benefit of priority to U.S. Provisional Application Ser. No. 63/682,564, filed Aug. 13, 2024, which is incorporated herein by reference in its entirety.

### TECHNICAL FIELD

The present disclosures relate to location-based information systems and, in some examples, to algorithms and systems to provide AI-generated information about landmarks based on a user's inferred location.

This technical field encompasses the integration of geolocation technology, artificial intelligence, and application interfaces to deliver contextually relevant educational content to users. The systems and methods described operate within the broader domains of social media platforms and interactive mapping technologies, leveraging these existing frameworks to enhance user engagement with historical and cultural information.

### BACKGROUND

Location-based information systems have evolved significantly with the advancement of mobile technologies, augmented reality (AR), and the widespread adoption of smartphones. These systems leverage geolocation data to provide users with contextually relevant information based on their physical location.

One of the many technical challenges in this field is accurately determining a user's location, especially in urban environments or indoor spaces where GPS signals may be unreliable. This often requires the use of multiple data sources and sophisticated algorithms to infer a user's precise position, which becomes even more critical when overlaying digital information in AR environments.

Another technical challenge lies in delivering relevant and engaging content to users based on their location, whether through mobile interfaces or AR displays. This involves not only identifying points of interest near the user but also curating and presenting information in a way that is both informative and easily digestible within the constraints of various display technologies.

The field also grapples with issues of scalability and performance, as location-based systems must handle large volumes of data and concurrent user requests across diverse geographical locations. This challenge extends to AR applications, which require real-time processing and rendering of complex 3D environments. Additionally, these systems may need to address concerns related to user privacy and data security, given the sensitive nature of location information and the potential for AR technologies to capture and process visual data from the user's surroundings.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a user interface diagram showing a map interface view of a location-based information system, according to some examples.

FIG. 2 is a user interface diagram illustrating a map interface integrated with an AI assistant to provide contextual information about geographic landmarks, and a chat interface, according to some examples.

FIG. 3 is a block diagram showing an example digital interaction system for facilitating interactions and engagements over a network, according to some examples.

FIG. 4 is a diagrammatic representation of a digital interaction system that has both client-side and server-side functionality, according to some examples.

FIG. 5 is a schematic diagram illustrating data structures, which may be stored in the database of the server system, according to certain examples.

FIG. 6 is a schematic diagram illustrating a structure of a message, according to some examples, generated by an interaction client for communication to a further interaction client via the servers.

FIG. 7 is a block diagram showing further technical details regarding operation of the prompt generator, to generate and deliver AI-generated information about geographic landmarks based on user location and context, according to some examples.

FIG. 8 is a flowchart illustrating a method for providing contextual historical information, according to some examples, of implementing a location-based information retrieval system.

FIG. 9 is a flowchart illustrating a method for providing AI-generated summaries about geographic landmarks to a user system, according to some examples, of integrating location-based services with artificial intelligence assistants.

FIG. 10 is a flowchart illustrating a method for displaying AI-generated summaries about geographic landmarks on a map interface, according to some examples, of integrating location-based services with artificial intelligence assistants.

FIG. 11 is a flowchart illustrating a method for precise location determination and triggering of location-based services, according to some examples, of enhancing geolocation accuracy for user systems within specific geographic locations.

FIG. 12 is a flowchart illustrating a method for determining when to query an AI assistant for information about a geographic landmark, according to some examples, of optimizing location-based services and AI interactions.

FIG. 13 is a flowchart illustrating a method for integrating AI assistant responses with a map interface, according to some examples, of enhancing user interaction with geographic landmark information.

FIG. 14 is a flowchart illustrating a method for processing and distributing AI-generated information about geographic landmarks to multiple user systems, according to some examples, of optimizing location-based services across different geographical locations.

FIG. 15 is a flowchart illustrating a method for providing augmented reality experiences with AI-generated information about geographic landmarks, according to some examples, of enhancing user interaction with physical environments through advanced mobile and wearable technologies.

FIG. 16 illustrates a system including a wearable apparatus with a selector input device, according to some examples.

FIG. 17 is a diagrammatic representation of a machine in the form of a computer system within which a set of instructions may be executed to cause the machine to perform any one or more of the methodologies discussed herein, according to some examples.

FIG. 18 is a block diagram showing a software architecture within which examples may be implemented.

FIG. 19 illustrates a machine-learning pipeline, according to some examples.

FIG. 20 illustrates training and use of a machine-learning program, according to some examples.

### DETAILED DESCRIPTION

### Overview

The described examples relate to technologies for providing location-based information to users through an AI assistant integrated with a map interface on a user system (e.g., mobile or AR device). These technologies aim to address technical challenges of users lacking access to relevant historical and contextual information about landmarks, museums, and other points of interest when visiting those locations. Currently, users may need to manually search for information or rely on physical guidebooks when exploring new places. The described examples seek to streamline this process by automatically providing AI-generated summaries about a user's surroundings.

The example components of the technologies include a location inference system, an AI assistant, a map interface, a graphical indication system, and a chat interface. The location inference system uses data from a user system to determine when a user is at or near a geographic landmark or point of interest. It may utilize various data sources such as GPS, Wi-Fi triangulation, and cellular network data to improve accuracy. The AI assistant is capable of generating summaries and important information about geographic landmarks and can be triggered automatically based on the user's inferred location.

In some examples, the system continuously monitors the user's location using the user system 302's sensors. When the user's location is determined to be at or near a geographic landmark, the system triggers the AI assistant. The AI assistant then generates a summary of information about the landmark. A graphical indication (e.g., AI assistant icon) of the AI-generated summary is displayed on the map interface, often appearing above a representation of the user (such as an avatar or Bitmoji). The user can interact with this graphical indication to view the summary or initiate a chat conversation with the AI assistant for more information.

The technologies also incorporate several additional features, such as animated transitions for the graphical indications, handling of multiple nearby landmarks, augmented reality integration, offline functionality using on-device AI models, customization options, and collaborative features for shared augmented reality experiences. Various techniques are used to optimize performance and user experience, including geofencing, confidence levels for triggering AI queries, battery optimization, caching of frequently requested information, and load balancing for multi-user scenarios.

The integration of these technologies with existing map and messaging interfaces allows for an improved user experience. Users can access AI-generated information about their surroundings without needing to switch between multiple apps or manually search for details about each location they visit. Overall, the described examples represent approaches to combining location-aware services, AI-generated content, and interactive map interfaces to provide users with contextual information about their surroundings in real-time, enhancing the user's exploration and learning experience when visiting new places.

### Map Interface 102

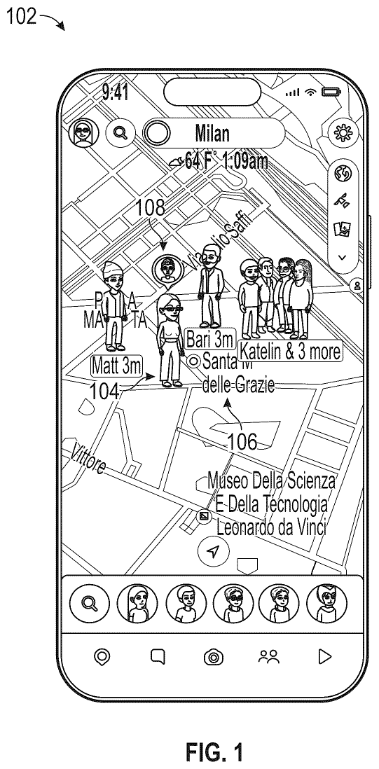

FIG. 1 is a user interface diagram showing a map interface 102 of a location-based information system, according to some examples.

The map interface 102 displays a geographical area with various user avatars 104 representing the locations of different users. Each user avatar 104 is positioned on the map to indicate the user's current location. The map interface 102 provides a visual representation of the area, including streets, landmarks, and other points of interest.

The landmark indicator 106 identifies specific landmarks or points of interest on the map. In this example, the landmark indicator 106 is associated with the “Santa Maria delle Grazie” landmark. The landmark indicator 106 provides users with a visual cue to identify important locations within the map interface 102.

The AI assistant icon 108 is displayed near the user avatars 104. The AI assistant icon 108 represents the presence of an AI assistant that can provide users with information about their surroundings. When a user is near a landmark or point of interest, the AI assistant icon 108 may appear to indicate that relevant information is available. This AI assistant icon 108 serves as a visual cue, alerting users to the availability of contextual information without requiring them to actively search for it. The appearance of the AI assistant icon 108 is designed to be intuitive and non-intrusive, integrating into the map interface to enhance the user experience.

Users can interact with the AI assistant icon 108 to receive AI-generated summaries and additional details about the landmark or point of interest. This interaction can be initiated through various user inputs, such as tapping or clicking on the icon. Upon interaction, the AI assistant may provide a concise summary of the most important information about the landmark, which may include historical facts, cultural significance, and other relevant details. The summary is designed to be easily digestible, providing users with valuable insights without overwhelming them with excessive information.

In addition to the initial summary, users have the option to delve deeper into the information provided by the AI assistant. By engaging in a chat conversation with the AI assistant, users can ask specific questions and receive more detailed responses. This interactive feature allows users to explore the landmark in greater depth, catering to their individual interests and curiosity. The chat interface is designed to be user-friendly, facilitating a natural and engaging dialogue between the user and the AI assistant.

The map interface 102 includes various interactive elements, such as search and navigation tools, to enhance user interaction. Users can utilize these tools to explore the map, locate friends, and access information about different locations. The integration of user avatars 104, landmark indicators 106, and the AI assistant icon 108 within the map interface 102 provides a comprehensive system for delivering location-based information and enhancing user engagement with their environment.

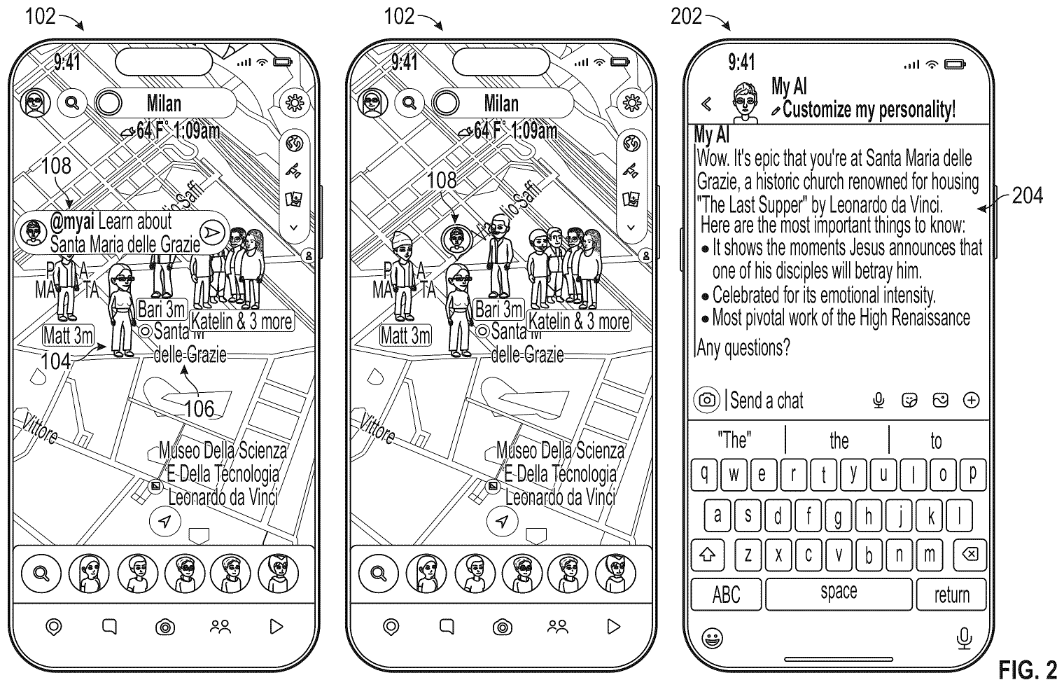

FIG. 2 is a user interface diagram illustrating a map interface 102 integrated with an AI assistant to provide contextual information about geographic landmarks, and a chat interface 202, according to some examples. The map interface 102 displays user avatars 104 representing the locations of different users. The landmark indicator 106 identifies specific landmarks or points of interest on the map. The AI assistant icon 108 is displayed near the user avatars 104, indicating the presence of an AI assistant that can provide information about the surroundings.

FIG. 2 demonstrates the transition of the AI assistant icon 108 from a first state to a second state. In the first state, the AI assistant icon 108 appears as a simple icon near the user avatar 104, signaling the availability of contextual information. Upon user interaction, such as tapping or clicking on the AI assistant icon 108, the icon transitions to the second state, where the AI assistant icon 108 expands into a graphical indication that includes text or other visual elements. This animated transition enhances user engagement by providing a visually appealing and intuitive way to access information.

Once the AI assistant icon 108 is selected, the chat interface 202 is displayed. The chat interface 202 presents AI-generated landmark information 204, for example providing a summary of important details about the geographic landmark. The AI assistant can personalize the information based on the user's profile and historical interactions. For example, if the user has shown interest in certain types of landmarks or historical periods, the AI assistant may prioritize and highlight relevant information, such as landmark information 204. This personalized approach seeks to ensure that the information provided is not only contextually relevant but also aligned with the user's preferences and interests, making the learning experience more engaging and meaningful.

This landmark information 204 is tailored to the user's location and can also take into account the interests and profiles of the user, and of other users connected to the user, enabling the user to engage in discussions with nearby users. For instance, the AI-generated landmark information 204 may include historical facts, cultural significance, and other relevant details about the landmark, as well as information that can be used to initiate conversations with other users who share similar interests or are located nearby.

The AI-generated landmark information 204 may be designed to be concise and informative, offering historical facts, cultural significance, and other relevant details about the landmark. The user can interact with the chat interface 202 to ask further questions and receive more detailed responses from the AI assistant, enhancing the learning experience and fostering engagement with the content. This interactive feature allows users to explore the landmark in greater depth, catering to their individual interests and curiosity.

### Digital Interaction System 300

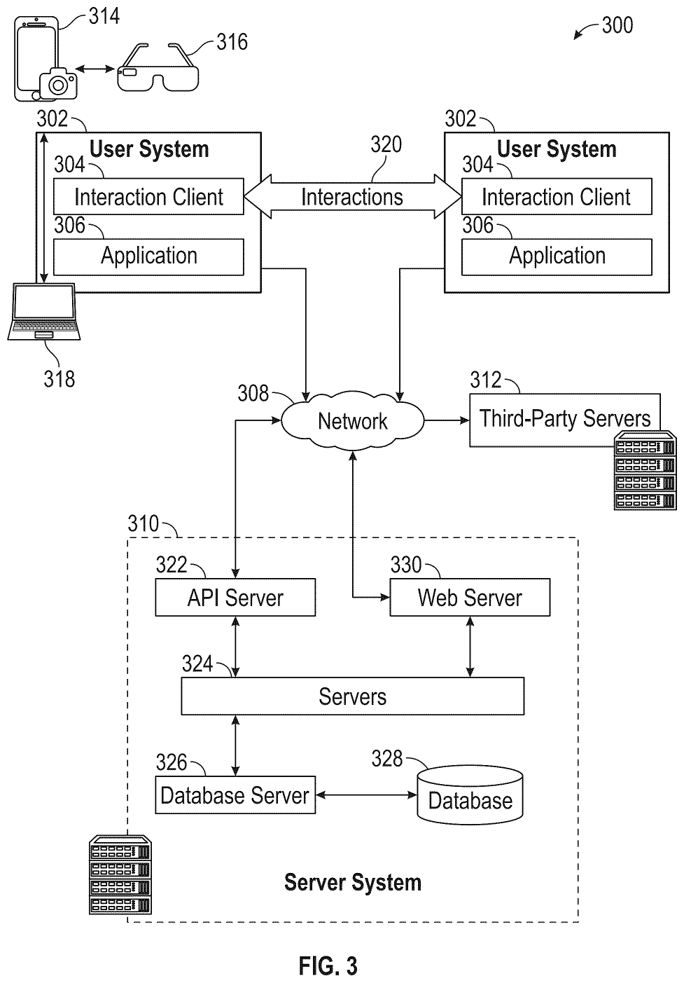

FIG. 3 is a block diagram showing an example digital interaction system 300 for facilitating interactions and engagements (e.g., exchanging text messages, conducting text audio and video calls, or playing games) over a network. The digital interaction system 300 includes multiple user systems 302, each of which hosts multiple applications, including an interaction client 304 and other applications 306. Each interaction client 304 is communicatively coupled, via one or more networks including a network 308 (e.g., the Internet), to other instances of the interaction client 304 (e.g., hosted on respective other user systems 302), a server system 310 and third-party servers 312). An interaction client 304 can also communicate with locally hosted applications 306 using Applications Program Interfaces (APIs).

Each user system 302 may include multiple user devices, such as a mobile device 314, wearable apparatus 316, and a computer client device 318 that are communicatively connected to exchange data and messages. The wearable apparatus 316 may be, for example, smart glasses, virtual reality (VR) headsets, fitness trackers, smartwatches, smart clothing, head-mounted displays (HMDs), hearing aids, smart helmets, wearable cameras, medical wearables, or earphones.

An interaction client 304 interacts with other interaction clients 304 and with the server system 310 via the Network 308. The data exchanged between the interaction clients 304 (e.g., interactions 320) and between the interaction clients 304 and the server system 310 includes functions (e.g., commands to invoke functions) and payload data (e.g., text, audio, video, or other multimedia data).

The server system 310 provides server-side functionality via the network 308 to the interaction clients 304. While certain functions of the digital interaction system 300 are described herein as being performed by either an interaction client 304 or by the server system 310, the location of certain functionality either within the interaction client 304 or the server system 310 may be a design choice. For example, it may be technically preferable to initially deploy particular technology and functionality within the server system 310 but to later migrate this technology and functionality to the interaction client 304 where a user system 302 has sufficient processing capacity.

The server system 310 supports various services and operations that are provided to the interaction clients 304. Such operations include transmitting data to, receiving data from, and processing data generated by the interaction clients 304. This data may include message content, client device information, geolocation information, digital effects (e.g., media augmentation and overlays), message content persistence conditions, entity relationship information, and live event information. Data exchanges within the digital interaction system 300 are invoked and controlled through functions available via user interfaces (UIs) of the interaction clients 304.

Turning now specifically to the server system 310, an Application Program Interface (API) server 322 is coupled to and provides programmatic interfaces to servers 324, making the functions of the servers 324 accessible to interaction clients 304, other applications 306 and third-party servers 312. The servers 324 are communicatively coupled to a database server 326, facilitating access to a database 328 that stores data associated with interactions processed by the servers 324. Similarly, a web server 330 is coupled to the servers 324 and provides web-based interfaces to the servers 324. To this end, the web server 330 processes incoming network requests over the Hypertext Transfer Protocol (HTTP) and several other related protocols.

The Application Program Interface (API) server 322 receives and transmits interaction data (e.g., commands and message payloads) between the servers 324 and the user systems 302 (and, for example, interaction clients 304 and other application 306) and the third-party server 312. Specifically, the Application Program Interface (API) server 322 provides a set of interfaces (e.g., routines and protocols) that can be called or queried by the interaction client 304 and other applications 306 to invoke functionality of the servers 324. The Application Program Interface (API) server 322 exposes various functions supported by the servers 324, including account registration; login functionality; the sending of interaction data, via the servers 324, from a particular interaction client 304 to another interaction client 304; the communication of media files (e.g., images or video) from an interaction client 304 to the servers 324; the settings of a collection of media data (e.g., a narrative); the retrieval of a list of friends of a user of a user system 302; the retrieval of messages and content; the addition and deletion of entities (e.g., friends) to an entity relationship graph (e.g., the entity graph 502); the location of friends within an entity relationship graph; and opening an application event (e.g., relating to the interaction client 304).

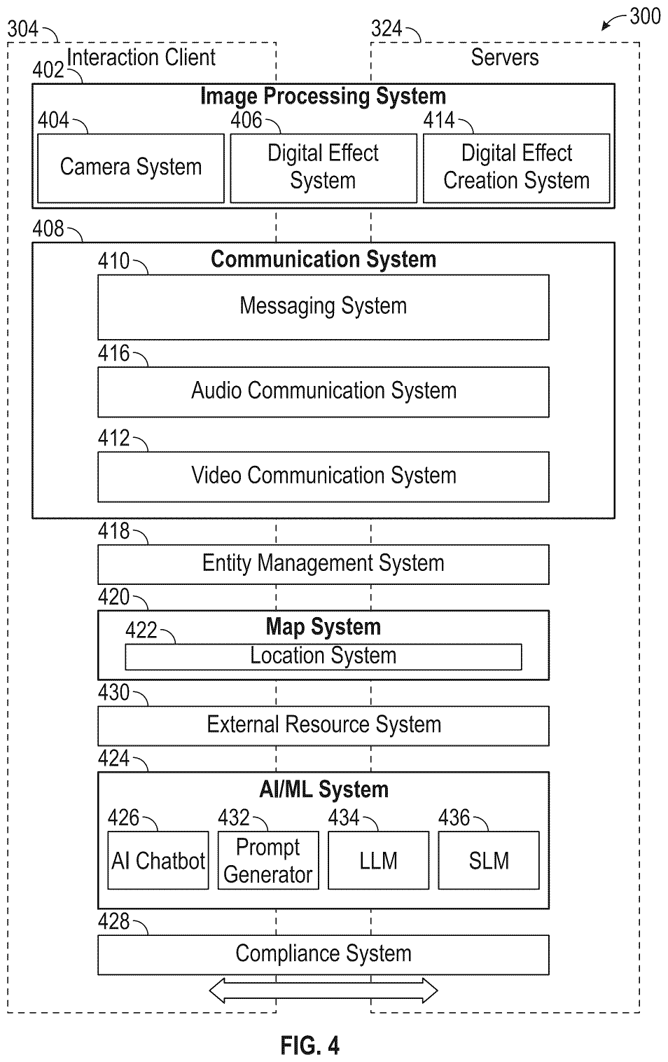

The servers 324 host multiple systems and subsystems, described below with reference to FIG. 4.

The interaction client 304 provides a user interface that allows users to access features and functions of an external resource, such as a linked application 306, an applet, or a microservice. This external resource may be provided by a third party or by the creator of the interaction client 304.

The external resource may be a full-scale application installed on a user system 302, or a smaller, lightweight version of the application, such as an applet or a microservice, hosted either on the user's system or remotely, such as on third-party servers 312 or in the cloud. These smaller versions, which include a subset of the full application's features, may be implemented using a markup-language document and may also incorporate a scripting language and a style sheet.

When a user selects an option to launch or access the external resource, the interaction client 304 determines whether the resource is web-based or a locally installed application. Locally installed applications can be launched independently of the interaction client 304, while applets and microservices can be launched or accessed via the interaction client 304.

If the external resource is a locally installed application, the interaction client 304 instructs the user's system to launch the resource by executing locally stored code. If the resource is web-based, the interaction client 304 communicates with third-party servers to obtain a markup-language document corresponding to the selected resource, which it then processes to present the resource within its user interface.

The interaction client 304 can also notify users of activity in one or more external resources. For instance, it can provide notifications relating to the use of an external resource by one or more members of a user group. Users can be invited to join an active external resource or to launch a recently used but currently inactive resource.

The interaction client 304 can present a list of available external resources to a user, allowing them to launch or access a given resource. This list can be presented in a context-sensitive menu, with icons representing different applications, applets, or microservices varying based on how the menu is launched by the user.

FIG. 4 is a block diagram illustrating further details regarding the digital interaction system 300, according to some examples. Specifically, the digital interaction system 300 is shown to comprise the interaction client 304 and the servers 324. The digital interaction system 300 embodies multiple subsystems, which are supported on the client-side by the interaction client 304 and on the server-side by the servers 324. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 300.
Data storage: A microservice subsystem may be responsible for its own data storage, which may be in the form of a database, cache, or other storage mechanism (e.g., using the database server 326 and database 328). This enables a microservice subsystem to operate independently of other microservices of the digital interaction system 300.
Service discovery: Microservice subsystems may find and communicate with other microservice subsystems of the digital interaction system 300. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 300 may employ a monolithic architecture, a service-oriented architecture (SOA), a function-as-a-service (FaaS) architecture, or a modular architecture.

An image processing system 402 provides various functions that enable a user to capture and modify (e.g., augment, annotate or otherwise edit) media content associated with a message.

A camera system 404 includes control software (e.g., in a camera application) that interacts with and controls hardware camera hardware (e.g., directly or via operating system controls) of the user system 302 to modify real-time images captured and displayed via the interaction client 304.

The digital effect system 406 provides functions related to the generation and publishing of digital effects (e.g., media overlays) for images captured in real-time by cameras of the user system 302 or retrieved from memory of the user system 302. For example, the digital effect system 406 operatively selects, presents, and displays digital effects (e.g., media overlays such as image filters or modifications) to the interaction client 304 for the modification of real-time images received via the camera system 404 or stored images retrieved from memory 1602 of a user system 302. These digital effects are selected by the digital effect system 406 and presented to a user of an interaction client 304, based on a number of inputs and data, such as for example:
Geolocation of the user system 302; and
Entity relationship information of the user of the user system 302.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 302 for communication in a message, or applied to video content, such as a video content stream or feed transmitted from an interaction client 304. As such, the image processing system 402 may interact with, and support, the various subsystems of the communication system 408, such as the messaging system 410 and the video communication system 412.

A media overlay may include text or image data that can be overlaid on top of a photograph taken by the user system 302 or a video stream produced by the user system 302. In some examples, the media overlay may be a location overlay (e.g., Venice beach), a name of a live event, or a name of a merchant overlay (e.g., Beach Coffee House). In further examples, the image processing system 402 uses the geolocation of the user system 302 to identify a media overlay that includes the name of a merchant at the geolocation of the user system 302. The media overlay may include other indicia associated with the merchant. The media overlays may be stored in the databases 328 and accessed through the database server 326.

The image processing system 402 provides a user-based publication platform that enables users to select a geolocation on a map and upload content associated with the selected geolocation. The user may also specify circumstances under which a particular media overlay should be offered to other users. The image processing system 402 generates a media overlay that includes the uploaded content and associates the uploaded content with the selected geolocation.

The digital effect creation system 414 supports augmented reality developer platforms and includes an application for content creators (e.g., artists and developers) to create and publish digital effects (e.g., augmented reality experiences) of the interaction client 304. The digital effect creation system 414 provides a library of built-in features and tools to content creators including, for example custom shaders, tracking technology, and templates.

In some examples, the digital effect creation system 414 provides a merchant-based publication platform that enables merchants to select a particular digital effect associated with a geolocation via a bidding process. For example, the digital effect creation system 414 associates a media overlay of the highest bidding merchant with a corresponding geolocation for a predefined amount of time.

A communication system 408 is responsible for enabling and processing multiple forms of communication and interaction within the digital interaction system 300 and includes a messaging system 410, an audio communication system 416, and a video communication system 412. The messaging system 410 is responsible, in some examples, for enforcing the temporary or time-limited access to content by the interaction clients 304. The messaging system 410 incorporates multiple timers that, based on duration and display parameters associated with a message or collection of messages (e.g., a narrative), selectively enable access (e.g., for presentation and display) to messages and associated content via the interaction client 304. The audio communication system 416 enables and supports audio communications (e.g., real-time audio chat) between multiple interaction clients 304. Similarly, the video communication system 412 enables and supports video communications (e.g., real-time video chat) between multiple interaction clients 304.

An entity management system 418 is operationally responsible for the management of user data and profiles, and maintains entity information (e.g., stored in entity tables 504, entity graphs 502 and profile data 506) regarding users and relationships between users of the digital interaction system 300.

The map system 420 provides various geographic location functions and supports the presentation of map-based media content and messages by the interaction client 304. For example, the map system 420 enables the display of user icons or avatars, stored in profile data 506, on a map to indicate the current or past location of “friends” of a user, as well as media content, such as collections of messages including photographs and videos, generated by such friends within the context of a map. For instance, a message posted by a user to the digital interaction system 300 from a specific geographic location may be displayed within the context of a map at that particular location to “friends” of a specific user on a map interface of the interaction client 304. A user can furthermore share their location and status information, using an appropriate status avatar, with other users of the digital interaction system 300 via the interaction client 304, with this location and status information being similarly displayed within the context of a map interface of the interaction client 304 to selected users.

The location system 422, as part of the map system 420, performs several operations to determine the location of a user and enhance the functionality of the map interface. The location system 422 works in conjunction with various components of the user system 302 to achieve accurate and efficient geolocation. It collects geolocation data from multiple sources, including GPS, Wi-Fi triangulation, Bluetooth beacons, and cellular network data. This multi-source approach helps improve the accuracy and reliability of the location data, especially in challenging environments such as urban areas or indoors. Additionally, the location system 422 integrates data from various sensors of the user system 302, such as accelerometers, gyroscopes, and magnetometers. This sensor fusion technique enhances the precision of location determination by combining different types of data to create a more accurate and comprehensive location profile.

The location system 422 continuously monitors the user's location and provides real-time updates to the map system 420. This ensures that the user's current location is accurately reflected on the map interface, allowing for dynamic and responsive interactions. It also supports geofencing capabilities, which involve defining virtual boundaries around specific geographic areas. When a user enters or exits a geofenced area, the location system 422 triggers specific actions, such as displaying relevant information or notifications on the map interface.

Working with the artificial intelligence and machine learning system 424, the location system 422 triggers AI-generated content based on the user's location. For example, when the location system 422 determines that a user is near a historical landmark, it can prompt the AI chatbot 426 to generate and display a summary of important information about the landmark. To conserve battery life, the location system 422 adjusts the frequency of location data updates based on user activity and context. For instance, it may reduce the frequency of GPS data collection when the user is stationary and increase it when the user is in motion.

The location system 422 also works with the compliance system 428 to ensure that location data is collected, processed, and stored in compliance with data privacy regulations such as GDPR and CCPA. This includes implementing measures to protect user privacy and providing users with control over their location data. Additionally, the location system 422 supports user interactions with the map interface, such as sharing their location with friends or checking into specific locations. It also collects user feedback on location accuracy and uses this data to improve the system's performance over time.

By performing these operations and communicating with other components of the user system 302, the location system 422 enhances the overall functionality and user experience of the map interface. It enables accurate and real-time geolocation, supports location-based content delivery, and ensures compliance with privacy regulations, making it a critical component of the digital interaction system 300.

An external resource system 430 provides an interface for the interaction client 304 to communicate with remote servers (e.g., third-party servers 312) to launch or access external resources, i.e., applications or applets. Each third-party server 312 hosts, for example, a markup language (e.g., HTML5) based application or a small-scale version of an application (e.g., game, utility, payment, or ride-sharing application). The interaction client 304 may launch a web-based resource (e.g., application) by accessing the HTML5 file from the third-party servers 312 associated with the web-based resource. Applications hosted by third-party servers 312 are programmed in JavaScript leveraging a Software Development Kit (SDK) provided by the servers 324. The SDK includes Application Programming Interfaces (APIs) with functions that can be called or invoked by the web-based application. The servers 324 host a JavaScript library that provides a given external resource access to specific user data of the interaction client 304. HTML5 is an example of technology for programming games, but applications and resources programmed based on other technologies can be used.

To integrate the functions of the SDK into the web-based resource, the SDK is downloaded by the third-party server 312 from the servers 324 or is otherwise received by the third-party server 312. Once downloaded or received, the SDK is included as part of the application code of a web-based external resource. The code of the web-based resource can then call or invoke certain functions of the SDK to integrate features of the interaction client 304 into the web-based resource.

The SDK stored on the server system 310 effectively provides the bridge between an external resource (e.g., applications 306 or applets) and the interaction client 304. This gives the user a seamless experience of communicating with other users on the interaction client 304 while also preserving the look and feel of the interaction client 304. To bridge communications between an external resource and an interaction client 304, the SDK facilitates communication between third-party servers 312 and the interaction client 304. A bridge script running on a user system 302 establishes two one-way communication channels between an external resource and the interaction client 304. Messages are sent between the external resource and the interaction client 304 via these communication channels asynchronously. Each SDK function invocation is sent as a message and callback. Each SDK function is implemented by constructing a unique callback identifier and sending a message with that callback identifier.

By using the SDK, not all information from the interaction client 304 is shared with third-party servers 312. The SDK limits which information is shared based on the needs of the external resource. Each third-party server 312 provides an HTML5 file corresponding to the web-based external resource to servers 324. The servers 324 can add a visual representation (such as a box art or other graphic) of the web-based external resource in the interaction client 304. Once the user selects the visual representation or instructs the interaction client 304 through a GUI of the interaction client 304 to access features of the web-based external resource, the interaction client 304 obtains the HTML5 file and instantiates the resources to access the features of the web-based external resource.

The interaction client 304 presents a graphical user interface (e.g., a landing page or title screen) for an external resource. During, before, or after presenting the landing page or title screen, the interaction client 304 determines whether the launched external resource has been previously authorized to access user data of the interaction client 304. In response to determining that the launched external resource has been previously authorized to access user data of the interaction client 304, the interaction client 304 presents another graphical user interface of the external resource that includes functions and features of the external resource. In response to determining that the launched external resource has not been previously authorized to access user data of the interaction client 304, after a threshold period of time (e.g., 3 seconds) of displaying the landing page or title screen of the external resource, the interaction client 304 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 304 adds the external resource to a list of authorized external resources and allows the external resource to access user data from the interaction client 304. The external resource is authorized by the interaction client 304 to access the user data under an OAuth 2 framework.

The interaction client 304 controls the type of user data that is shared with external resources based on the type of external resource being authorized. For example, external resources that include full-scale applications (e.g., an application 306) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An artificial intelligence and machine learning system 424 provides a variety of services to different subsystems within the digital interaction system 300. For example, the artificial intelligence and machine learning system 424 operates with the image processing system 402 and the camera system 404 to analyze images and extract information such as objects, text, or faces. This information can then be used by the image processing system 402 to enhance, filter, or manipulate images. The artificial intelligence and machine learning system 424 may be used by the digital effect system 406 to generate modified content and augmented reality experiences, such as adding virtual objects or animations to real-world images. The communication system 408 and messaging system 410 may use the artificial intelligence and machine learning system 424 to analyze communication patterns and provide insights into how users interact with each other and provide intelligent message classification and tagging, such as categorizing messages based on sentiment or topic. The artificial intelligence and machine learning system 424 may also provide chatbot functionality to message interactions 320 between user systems 302 and between a user system 302 and the server system 310. Specifically, the AI chatbot 426 facilitates these interactions, ensuring that users receive timely and relevant responses. The artificial intelligence and machine learning system 424 may also work with the audio communication system 416 to provide speech recognition and natural language processing capabilities, allowing users to interact with the digital interaction system 300 using voice commands.

The AI/ML system 424 includes several example components that enable these functionalities. One of the components is the AI chatbot 426, which interacts with users to provide information, answer questions, and facilitate various tasks. The AI chatbot 426 is supported by a prompt generator 432, which formulates queries and responses based on user input and contextual data. This ensures that the interactions are relevant and informative. The prompt generator 432 enhances the chatbot's ability to understand and respond to user queries accurately, making the interactions more natural and engaging.

Another example component of the AI/ML system 424 is the Large Language Model (LLM) 434, which may be server-based. The LLM 434 processes extensive datasets to generate sophisticated and contextually accurate responses. This server-based model leverages powerful computational resources to handle complex language processing tasks, ensuring high-quality interactions with users. The LLM 434 handles large volumes of data and providing deep insights, which are essential for generating detailed and accurate responses.

In addition to the Large Language Model (LLM) 434, the AI/ML system 424 may also include one or more a Small Language Model (SLM) 436, which may reside on one or more components of the user system 302. The SLM 436 is designed to operate on local devices, providing quick and responsive language processing capabilities even when the user system 302 is offline or has limited connectivity. This on-device model ensures that users can still access essential AI functionalities without relying solely on server-based resources. The SLM 436 is optimized for performance and efficiency, making it suitable for real-time applications where low latency is critical.

The AI/ML system 424 communicates with other subsystems within the digital interaction system 300. For instance, it collaborates with the entity management system 418 to personalize interactions based on user profiles and preferences. The map system 420 and location system 422 provide geolocation data that the AI/ML system 424 uses to generate location-specific content and recommendations. The external resource system 430 allows the AI/ML system 424 to access additional data and services from third-party servers, enhancing its capabilities and the overall user experience.

Furthermore, the AI/ML system 424 ensures compliance with data privacy regulations through its integration with a compliance system 428. This includes implementing measures to protect user data and providing transparency and control over data usage. By working in concert with these various components, the AI/ML system 424 enhances the functionality, responsiveness, and personalization of the digital interaction system 300, making it a vital part of the overall architecture.

The compliance system 428 facilitates compliance by the digital interaction system 300 with data privacy and other regulations, including for example the California Consumer Privacy Act (CCPA), General Data Protection Regulation (GDPR), and Digital Services Act (DSA). The compliance system 428 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 428 also incorporates opt-in/opt-out management and privacy controls across the digital interaction system 300, empowering users to manage their data preferences. The compliance system 428 is designed to handle sensitive data by obtaining explicit consent, implementing strict access controls and in accordance with applicable laws.

### Data Structures 500

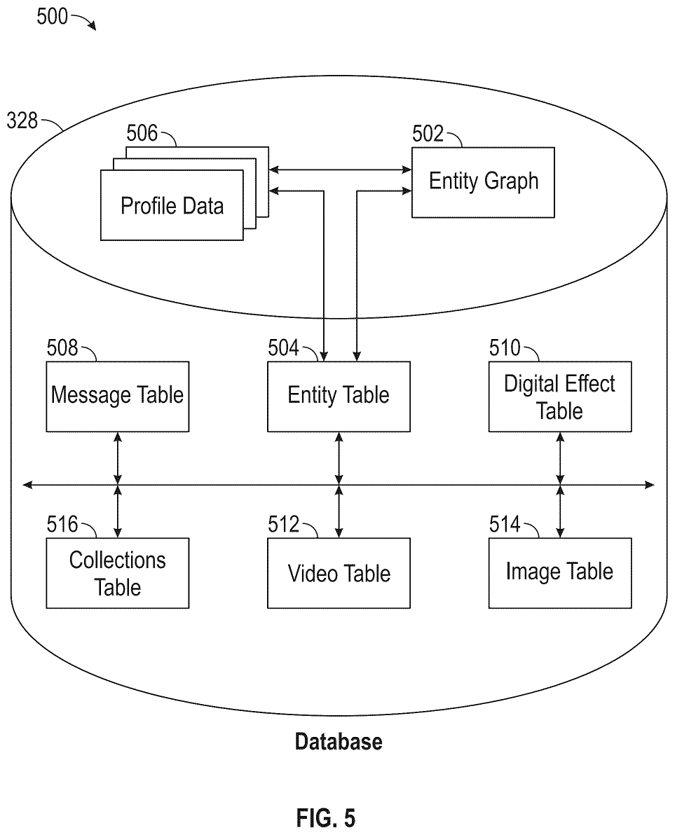

FIG. 5 is a schematic diagram illustrating data structures 500, which may be stored in the database 328 of the server system 310, according to certain examples. While the content of the database 328 is shown to comprise multiple tables, it will be appreciated that the data could be stored in other types of data structures (e.g., as an object-oriented database).

The database 328 includes message data stored within a message table 508. This message data includes at least message sender data, message recipient (or receiver) data, and a payload. Further details regarding information that may be included in a message, and included within the message data stored in the message table 508, are described below with reference to FIG. 5.

An entity table 504 stores entity data, and is linked (e.g., referentially) to an entity graph 502 and profile data 506. Entities for which records are maintained within the entity table 504 may include individuals, corporate entities, organizations, objects, places, events, and so forth. Regardless of entity type, any entity regarding which the server system 310 stores data may be a recognized entity. Each entity is provided with a unique identifier, as well as an entity type identifier (not shown).

The entity graph 502 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 300.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 504. Such privacy settings may be applied to all types of relationships within the context of the digital interaction system 300, or may selectively be applied to certain types of relationships.

The profile data 506 stores multiple types of profile data about a particular entity. The profile data 506 may be selectively used and presented to other users of the digital interaction system 300 based on privacy settings specified by a particular entity. Where the entity is an individual, the profile data 506 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 300, and on map interfaces displayed by interaction clients 304 to other users. The collection of avatar representations may include “status avatars,” which present a graphical representation of a status or activity that the user may select to communicate at a particular time.

Where the entity is a group, the profile data 506 for the group may similarly include one or more avatar representations associated with the group, in addition to the group name, members, and various settings (e.g., notifications) for the relevant group.

The entity table 504 can store a wide range of data for various entity types, including landmarks. For landmark entities, the stored data may encompass:
Unique identifier: A distinct alphanumeric code assigned to each landmark for unambiguous identification within the system.
Entity type identifier: A field indicating the entity is classified as a “landmark” or similar designation.
Name: The official and alternative names of the landmark.
Geographic coordinates: Precise latitude and longitude values, potentially including altitude information for multi-level structures.
Address information: Structured fields for street, city, state/province, country, and postal code, along with any additional addressing systems used in the landmark's location.
Description: A comprehensive textual description of the landmark, potentially including multiple versions of varying lengths for different use cases.
Historical significance: Detailed information about the landmark's role in historical events, cultural movements, or architectural developments.
Architectural details: Technical specifications of the landmark's construction, including materials used, structural elements, and unique architectural features.
Temporal data: Dates related to the landmark's construction, significant modifications, or historical events, stored in a standardized format for easy querying and comparison.
Cultural importance: Information on the landmark's significance in local, national, or global cultural contexts, potentially including references to literature, art, or media featuring the landmark.
Associated entities: Links to profiles of historical figures, architects, or organizations connected to the landmark, leveraging the entity graph for complex relationship mapping.
Operational information: Structured data on opening hours, seasonal variations, and special closures, stored in a machine-readable format for easy integration with scheduling systems.
Accessibility features: Detailed information on facilities and accommodations for visitors with various needs, potentially including data on ramp locations, elevator specifications, or assistive technologies available.
Capacity and crowd management: Data on visitor capacity limits, average daily visitor counts, and peak times, which can be used for predictive modeling and resource allocation.
Governance and management: Information on the organizations responsible for the landmark's upkeep, including contact details and jurisdictional boundaries.
Conservation status: Technical details on the landmark's current condition, ongoing preservation efforts, and any risks or challenges to its long-term survival.
Recognition and designations: Information on official recognitions such as UNESCO World Heritage status, including the criteria met for such designations and any associated obligations.
Visitor behavior patterns: Anonymized data on typical visitor routes through the landmark, average visit duration, and popular viewpoints or features.
Surrounding context: Information on nearby points of interest, transportation nodes, and services, potentially including geospatial relationships and walking times.
Transportation and access: Detailed data on public transit options, including route numbers, frequencies, and real-time service information where available.
Parking facilities: Information on available parking options, including capacity, pricing structures, and real-time occupancy data where applicable.
Pricing and ticketing: Comprehensive data on entry fees, including variations based on visitor type, time of day, or special events, along with information on ticketing systems and purchase options.
Tour and guide services: Details on available guided tours, including languages offered, duration, and capacity, potentially with links to booking systems.
Media policies: Structured data on photography, videography, and drone usage policies, including any restricted areas or time-based limitations.
Event calendar: A database of past, current, and future events associated with the landmark, including recurring events and one-time special exhibitions.
Digital presence: Links to official websites, social media profiles, and virtual tour platforms, potentially including API endpoints for real-time data integration.
User-generated content: Aggregated data from visitor reviews, ratings, and shared media, with metadata on submission dates and user demographics.
Environmental impact: Technical data on the landmark's energy consumption, waste management practices, and any initiatives for reducing environmental impact.
Research and academic resources: Information on archives, libraries, or research facilities associated with the landmark, including access policies and notable collections.
Geofence data: Detailed geospatial information defining the landmark's boundaries and associated zones.
   The Geofence Data Associated with Landmarks May Include:
Boundary definition: A series of geographic coordinates defining the polygon that encompasses the landmark's physical extent.
Multi-level geofencing: For complex structures, three-dimensional geofence data that accounts for different levels or floors within the landmark.
Buffer zones: Additional polygons defining areas around the main landmark boundary, potentially with different rules or monitoring requirements.
Entry and exit points: Specific coordinates or linear features representing official ingress and egress locations, which can be used for visitor flow analysis or security monitoring.
Internal zones: Subdivisions within the main geofence, delineating areas with different access levels, usage rules, or historical significance.
Time-based variations: Data structures allowing for geofence definitions to change based on time of day, day of week, or specific dates, accommodating events or seasonal changes.
Permitted activities: Metadata associated with different zones within the geofence, specifying allowed and prohibited activities, which can be used for automated notifications or enforcement systems.
Signal propagation models: Technical data on how wireless signals (e.g., GPS, Wi-Fi, Bluetooth) behave within the geofenced area, accounting for physical obstructions and materials that may affect location accuracy.
Geofence intersection logic: Rules for handling scenarios where a user or device is detected in multiple overlapping geofences, prioritizing which landmark's information should be presented.
Dynamic geofencing: Algorithms and data structures supporting real-time modification of geofence boundaries based on factors such as crowd density or environmental conditions.

This entity data structure enables the entity management system 418 to provide rich, context-aware information to the prompt generator 432. The prompt generator 432 can then leverage this comprehensive dataset to create prompts to solicit detailed, accurate, and relevant AI-generated summaries about landmarks. The digital interaction system 300 can dynamically adjust the content and presentation of information based on factors such as the user's location within the geofenced area, time of visit, and personal preferences, enhancing the overall user experience and educational value of the application.

The database 328 also stores digital effect data, such as overlays or filters, in a digital effect table 510. The digital effect data is associated with and applied to videos (for which data is stored in a video table 512) and images (for which data is stored in an image table 514).

Filters, in some examples, are overlays that are displayed as overlaid on an image or video during presentation to a recipient user. Filters may be of various types, including user-selected filters from a set of filters presented to a sending user by the interaction client 304 when the sending user is composing a message. Other types of filters include geolocation filters (also known as geo-filters), which may be presented to a sending user based on geographic location. For example, geolocation filters specific to a neighborhood or special location may be presented within a user interface by the interaction client 304, based on geolocation information determined by a Global Positioning System (GPS) unit of the user system 302.

Another type of filter is a data filter, which may be selectively presented to a sending user by the interaction client 304 based on other inputs or information gathered by the user system 302 during the message creation process. Examples of data filters include current temperature at a specific location, a current speed at which a sending user is traveling, battery life for a user system 302, or the current time.

Other digital effect data that may be stored within the image table 514 includes augmented reality content items (e.g., corresponding to augmented reality experiences). An augmented reality content item may be a real-time special effect and sound that may be added to an image or a video.

A collections table 516 stores data regarding collections of messages and associated image, video, or audio data, which are compiled into a collection (e.g., a narrative or a gallery). The creation of a particular collection may be initiated by a particular user (e.g., each user for which a record is maintained in the entity table 504). A user may create a “personal collection” in the form of a collection of content that has been created and sent/broadcast by that user. To this end, the user interface of the interaction client 304 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 304, to contribute content to a particular live collection. The live collection may be identified to the user by the interaction client 304, based on his or her location.

A further type of content collection is known as a “location collection,” which enables a user whose user system 302 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 512 stores video data that, in some examples, is associated with messages for which records are maintained within the message table 508. Similarly, the image table 514 stores image data associated with messages for which message data is stored in the entity table 504. The entity table 504 may associate various digital effects from the digital effect table 510 with various images and videos stored in the image table 514 and the video table 512.

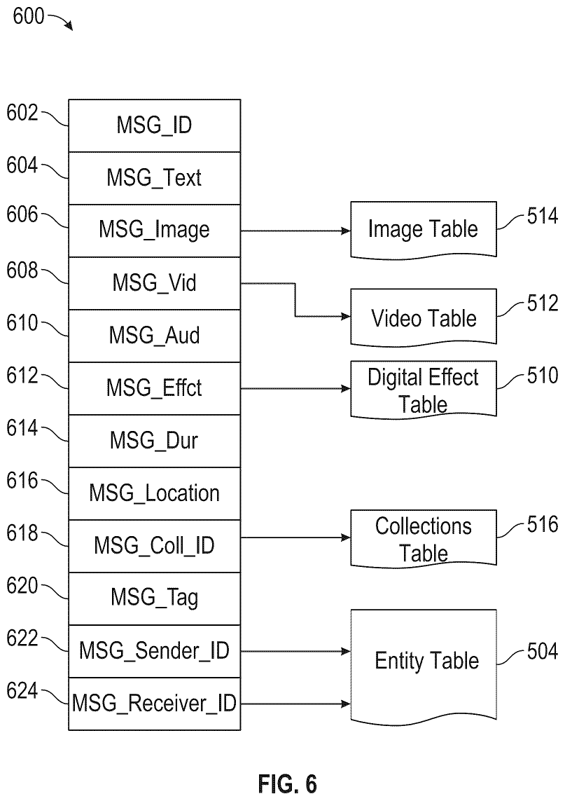

FIG. 6 is a schematic diagram illustrating a structure of a message 600, according to some examples, generated by an interaction client 304 for communication to a further interaction client 304 via the servers 324. The content of a particular message 600 is used to populate the message table 508 stored within the database 328, accessible by the servers 324. Similarly, the content of a message 600 is stored in memory as “in-transit” or “in-flight” data of the user system 302 or the servers 324. A message 600 is shown to include the following example components:
Message identifier 602: a unique identifier that identifies the message 600.
Message text payload 604: text, to be generated by a user via a user interface of the user system 302, and that is included in the message 600.
Message image payload 606: image data, captured by a camera component of a user system 302 or retrieved from a memory component of a user system 302, and that is included in the message 600. Image data for a sent or received message 600 may be stored in the image table 514.
Message video payload 608: video data, captured by a camera component or retrieved from a memory component of the user system 302, and that is included in the message 600. Video data for a sent or received message 600 may be stored in the video table 512.
Message audio payload 610: audio data, captured by a microphone or retrieved from a memory component of the user system 302, and that is included in the message 600.
Message digital effect data 612: digital effect data (e.g., filters, stickers, or other annotations or enhancements) that represents digital effects to be applied to message image payload 606, message video payload 608, or message audio payload 610 of the message 600. Digital effect data for a sent or received message 600 may be stored in the digital effect table 510.
Message duration parameter 614: parameter value indicating, in seconds, the amount of time for which content of the message (e.g., the message image payload 606, message video payload 608, message audio payload 610) is to be presented or made accessible to a user via the interaction client 304.
Message geolocation parameter 616: geolocation data (e.g., latitudinal, and longitudinal coordinates) associated with the content payload of the message. Multiple message geolocation parameter 616 values may be included in the payload, each of these parameter values being associated with respect to content items included in the content (e.g., a specific image within the message image payload 606, or a specific video in the message video payload 608).
Message collection identifier 618: identifier values identifying one or more content collections (e.g., “stories” identified in the collections table 516) with which a particular content item in the message image payload 606 of the message 600 is associated. For example, multiple images within the message image payload 606 may each be associated with multiple content collections using identifier values.
Message tag 620: each message 600 may be tagged with multiple tags, each of which is indicative of the subject matter of content included in the message payload. For example, where a particular image included in the message image payload 606 depicts an animal (e.g., a lion), a tag value may be included within the message tag 620 that is indicative of the relevant animal. Tag values may be generated manually, based on user input, or may be automatically generated using, for example, image recognition.
Message sender identifier 622: an identifier (e.g., a messaging system identifier, email address, or device identifier) indicative of a user of the user system 302 on which the message 600 was generated and from which the message 600 was sent.
Message receiver identifier 624: an identifier (e.g., a messaging system identifier, email address, or device identifier) indicative of a user of the user system 302 to which the message 600 is addressed.

The contents (e.g., values) of the various components of message 600 may be pointers to locations in tables within which content data values are stored. For example, an image value in the message image payload 606 may be a pointer to (or address of) a location within an image table 514. Similarly, values within the message video payload 608 may point to data stored within a video table 512, values stored within the message digital effect data 612 may point to data stored in a digital effect table 510, values stored within the message collection identifier 618 may point to data stored in a collections table 516, and values stored within the message sender identifier 622 and the message receiver identifier 624 may point to user records stored within an entity table 504.

### Prompt Generator 432

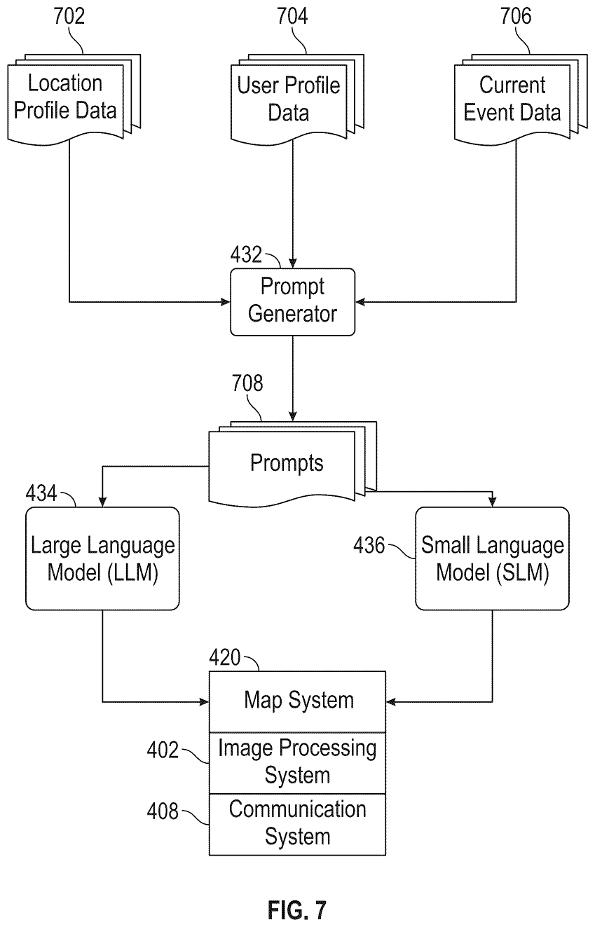

FIG. 7 is a block diagram showing further technical details regarding operation of the prompt generator 432, to generate and deliver AI-generated information about geographic landmarks based on user location and context, according to some examples. Several components are shown that interact to provide relevant and personalized information to users.

The location profile data 702 is collected from various sources such as GPS, Wi-Fi triangulation, and cellular network data. This data is used to determine the user's current location with high accuracy.

The user profile data 704 contains information about the user's preferences, historical interactions, and other personalized settings. This data helps tailor the information provided to the user's interests. The current event data 706 includes information about ongoing events, activities, or other dynamic content relevant to the user's location. This data ensures that the information provided is up-to-date and contextually relevant.

The prompt generator 432 receives inputs from the entity management system 418 including the location profile data 702, user profile data 704, and current event data 706. The prompt generator 432 processes these inputs to create prompts 708, which are queries or instructions that guide the AI models in generating relevant information. The prompts 708 are then communicated to either the Large Language Model (LLM) 434 or the Small Language Model (SLM) 436, depending on the context and requirements.

Examples of Prompts that the Prompt Generator 432 May be:
“Summarize the key historical facts about [landmark name] for a first-time visitor.”
“What are the top 3 must-see exhibits at [museum name] based on [user]'s interests in [art period/style]?”
“Provide a brief overview of [landmark name]'s architectural significance, focusing on [specific architectural feature].”
“Describe the cultural importance of [landmark name] in the context of [historical event/period].”
“What are the current exhibitions or events happening at [landmark/museum name] today?”

The prompt generator 432 employs a various examples processes to create tailored, context-aware prompts that guide the AI models in generating relevant and personalized information for users at specific landmarks or museums, for example. This process involves several example operations that leverage the available data and system capabilities.

Initially, the prompt generator 432 aggregates data from various sources, including location profile data 702, user profile data 704, and current event data 706. T

Following data aggregation, the prompt generator 432 conducts an analysis of the collected information to understand the current context. This analysis takes into account factors such as the user's location, personal interests, and any ongoing events at the landmark. By processing this contextual information, the prompt generator 432 can tailor its prompts to the specific circumstances of each user interaction.

Based on the analyzed context, the prompt generator 432 may select an appropriate template from a predefined set of prompt structures. These templates may serve as the base for creating customized prompts. The prompt generator 432 then dynamically inserts specific details into the selected template, such as the landmark name, user interests, or current events, resulting in a personalized prompt.

To further refine the prompt selection, the prompt generator 432 may employ algorithms to score the relevance of different prompt options based on the current context and user profile. This scoring mechanism helps generate appropriate prompt for each situation.

The generated prompts undergo an optimization process tailored to the specific characteristics and capabilities of the target language model, whether it's the Large Language Model (LLM) 434 or the Small Language Model (SLM) 436. This optimization may involve adjusting the prompt length, complexity, and structure to align with the strengths and limitations of each model. For the LLM 434, which may have more extensive knowledge and processing capabilities, the prompts may be more detailed and nuanced. In contrast, prompts for the SLM 436 may be more concise and focused, considering its potentially more limited processing capacity. The optimization process may also involve fine-tuning the prompts based on historical performance data, ensuring that they consistently elicit high-quality and relevant responses from the respective language model.

The prompt generator 432 may also incorporate contextual adaptation, adjusting its output based on factors such as the user's interaction history, time of day, or device capabilities. This adaptive approach allows for more nuanced and relevant prompt generation.

Finally, the prompt generator 432 queues and prioritizes the generated prompts for processing by the appropriate language model. This prioritization takes into account factors such as urgency and resource availability, ensuring efficient handling of prompt requests.

The Large Language Model (LLM) 434 is a server-based AI model that processes extensive datasets to generate sophisticated and contextually accurate responses. The LLM 434 leverages powerful computational resources to handle complex language processing tasks, ensuring high-quality interactions with users. The Small Language Model (SLM) 436 is designed to operate on local devices, providing quick and responsive language processing capabilities even when the user system 302 is offline or has limited connectivity. The SLM 436 ensures that users can still access AI functionalities without relying solely on server-based resources.

The outputs from the LLM 434 and SLM 436 are integrated into the map system 420, image processing system 402, and communication system 408. The map system 420 provides various geographic location functions and supports the presentation of map-based media content and messages. The image processing system 402 enables the capture and modification of media content associated with a message. The communication system 408 facilitates multiple forms of communication and interaction within the digital interaction system, including messaging, audio, and video communications.

The integration of these components allows the system to deliver AI-generated summaries and contextual information about geographic landmarks directly to the user's device. The information is displayed on the map interface, often appearing above a representation of the user, such as an avatar. Users can interact with this graphical indication to view the summary or initiate a chat conversation with the AI assistant for more information. This system enhances the user experience by providing seamless, real-time access to relevant and personalized information about their surroundings.

### Method 800

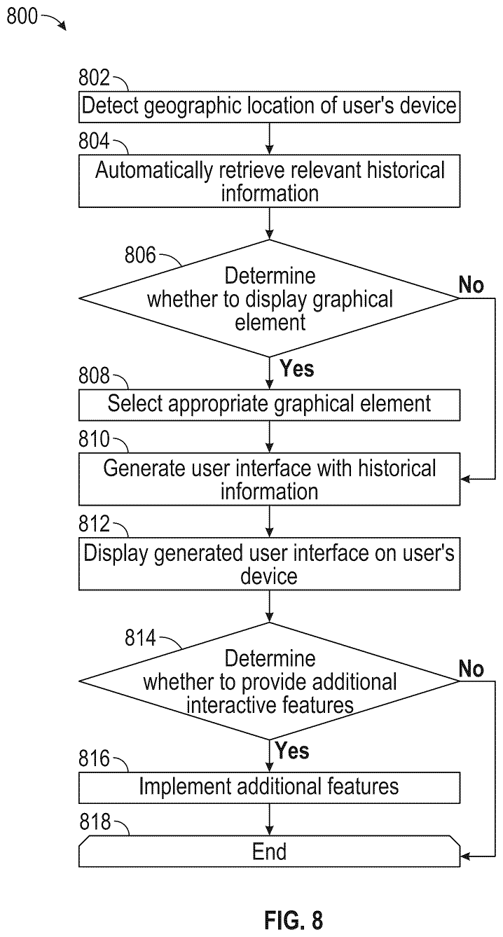

FIG. 8 is a flowchart illustrating a method 800 for providing contextual historical information, according to some examples, of implementing a location-based information retrieval system.

Although the example method depicted in FIG. 8 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 802, the digital interaction system 300 detects a geographic location of a user system 302. This detection may be performed by the location system 422 utilizing various technologies. In some examples, the location system 422 may employ global positioning system (GPS) technology to determine the device's coordinates. Other methods may include QR code scanning, RFID detection, or manual input by the user.

In some examples, the location system 422 may employ a multi-layered approach to detect and refine the geographic location of a user system 302. This process may begin with the collection of geolocation data from one or more of multiple sources, including GPS, Wi-Fi triangulation, Bluetooth beacons, and cellular network data. By integrating these diverse data streams, the location system 422 enhances the accuracy and reliability of location information, particularly in challenging environments such as urban areas or indoor spaces.

To further improve precision, the location system 422 may user data from various sensors within the user system 302, such as accelerometers, gyroscopes, and magnetometers. This sensor fusion technique combines different types of data to create a more comprehensive location profile. Advanced algorithms, like Kalman filtering, may be employed to optimally merge these data streams, resulting in a more robust location estimate.

The location system 422 operates intermittently or continuously, monitoring the user's location and providing real-time updates to the map system 420. This monitoring ensures that the user's current position is accurately reflected on the map interface 102, enabling dynamic and responsive interactions. Additionally, the location system 422 supports geofencing capabilities, defining virtual boundaries around specific geographic areas. When a user enters or exits a geofenced area, the location system 422 can trigger specific actions, such as displaying relevant information or notifications on the map interface.

To optimize power consumption while maintaining necessary location accuracy, the location system 422 may implement adaptive sampling rates. For example, the location system 422 may adjust the frequency of location data updates based on user activity and context. For instance, the location system 422 may reduce the frequency of GPS data collection when the user is stationary and increase it when the user is in motion.

In scenarios where GPS signals are weak or unavailable, such as inside buildings or underground structures, the location system 422 can utilize alternative indoor positioning technologies. These may include Bluetooth Low Energy (BLE) beacons, Ultra-wideband (UWB) technology, or visual positioning systems that use the device's camera to recognize visual landmarks and determine location.

At block 804, the digital interaction system 300 automatically retrieves information relevant to the detected location. This retrieval process may be executed by the artificial intelligence and machine learning system 424, using the prompt generator 432, to generate AI-generated landmark information 204 relevant to the detected location.

At decision block 806, the digital interaction system 300, for example the map system 420, determines whether to display a graphical element along with the retrieved information on the map interface 102. This decision may be based on factors such as the nature of the historical information, user preferences, or device capabilities. The map system 420 may employ rule-based algorithms or machine learning models to make this determination.

At block 808, if the digital interaction system 300 determines affirmatively to display a graphical element, it selects an appropriate visual representation. To this end, the map system 420 may involve choosing between different types of graphical elements such as images, icons, or interactive widgets. In some examples, the map system 420 may determine to cause display of an AI assistant icon 108 on the map interface 102, at or near a user avatar 104, that enables the user to invoke an AI chatbot 426 that may present the retrieved information. The map interface 102 may be presented within the context of the interaction client 304 on a mobile device or on a display of the wearable apparatus 316. The map interface 102 may be presented using may augmented reality technology to overlay the retrieved information on a real-time image captured by a camera of the mobile device 314 or a user system 302 or on an optical see-through display (e.g., of the wearable apparatus 316)

At block 810, the digital interaction system 300 generates a user interface (e.g., the map interface 102) that incorporates at least a portion of the retrieved historical information and, if applicable, the selected graphical element (e.g., the AI assistant icon 108). The interaction client 304 may arrange these elements according to predefined templates or dynamically based on the content and context. In some examples, the information may be displayed proximate to a graphical representation of the user (e.g., user avatar 104) on a digital map (e.g., the map interface 102) or as a pop-up notification on the user system 302.

At block 812, the digital interaction system 300 displays the generated user interface on the user's device within an application interface. This may involve rendering the interface elements and ensuring proper layout and responsiveness across different screen sizes and device types.

At decision block 814, the digital interaction system 300 evaluates whether to provide additional interactive features to enhance the user experience. This determination is based on various factors, including user preferences, the complexity of the information presented, and the capabilities of the interaction client 304. If the digital interaction system 300 decides to offer additional features, it proceeds to implement them, enriching the user's interaction with the historical content.

The method 800 may extend beyond the basic presentation of information to include a range of interactive features. One such example feature is the integration of a chat interface 202 with an AI assistant (e.g., the AI chatbot 426) to present the retrieved information and to enable the user to further engage with information about the location. This allows users to engage in a more dynamic and personalized exploration of the information. Users can ask questions, seek clarifications, or delve deeper into specific aspects of the landmark or venue (e.g., museum) they are visiting, receiving AI-generated responses tailored to their inquiries.

Another example feature that may be implemented is the ability to share retrieved information directly through the messaging system 410 of the digital interaction system 300 with other users. This functionality enables users to easily disseminate interesting facts or insights about the landmarks they visit, potentially increasing engagement and fostering a community of enthusiasts or friends.

The digital interaction system 300 may also offer the retrieved information in multiple selectable languages, catering to a diverse user base and improving accessibility. This feature allows users to choose their preferred language, ensuring that the e content is comprehensible and engaging for a global audience. The multilingual support enhances the inclusivity of the application and broadens its educational impact.

Furthermore, the digital interaction system 300 may provide users with the ability to customize the type of information they receive from the AI chatbot 426, for example. This personalization feature allows users to tailor their experience based on their interests, whether they prefer architectural details, cultural significance, or historical events. By offering this level of customization, the digital interaction system 300 can deliver relevant and engaging content to each user.

The method 800 may also include alerting users when they are in proximity to landmarks (e.g., via the messaging system 410 or the map interface 102) with relevant information. This proactive approach encourages users to explore their surroundings and learn about nearby points of interest, even if they were not actively seeking such information. These notifications can be tailored based on user preferences and location data to ensure relevance and avoid overwhelming the user.

### Method 900

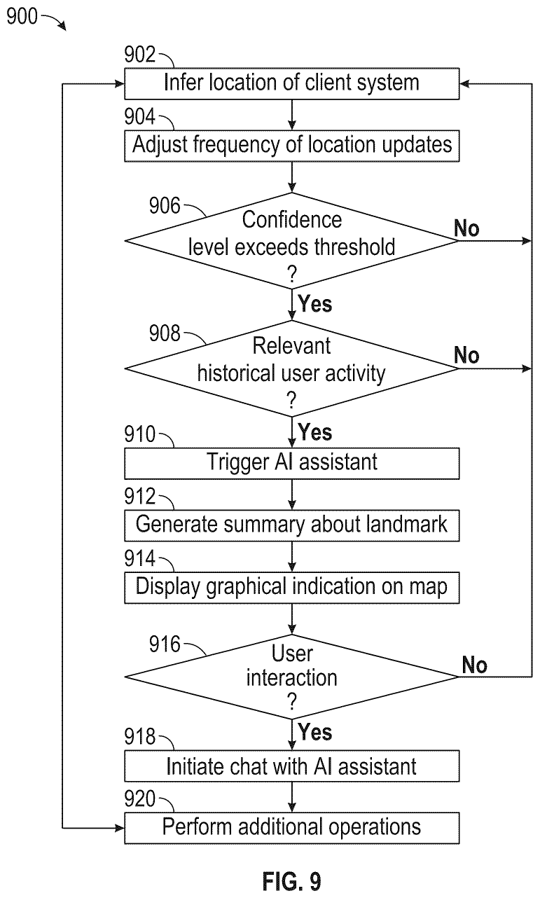

FIG. 9 is a flowchart illustrating a method 900 for providing AI-generated summaries about geographic landmarks to a user system 302, according to some examples, of integrating location-based services with artificial intelligence assistants.

Although the example method depicted in FIG. 9 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 902, the digital interaction system 300, for example using the location system 422, infers a location of a user system 302 at a geographic landmark based on location data. As noted above, this inference may be performed automatically using at least one processor. In some examples, the location data may include global positioning system (GPS) data, Wi-Fi triangulation data, or data from multiple sensors of the user system 302.

At block 904, the location system 422 employs an adaptive approach to adjust the frequency of location data updates based on user activity and context. This dynamic adjustment process is designed to optimize power consumption while maintaining the necessary level of location accuracy for the application's functionality.

In some examples, the location system 422 utilizes a combination of sensor data and contextual information to determine the appropriate update frequency. For instance, accelerometer and gyroscope data from the user system 302 may be analyzed to detect movement patterns. When the location system 422 detects that the device is stationary, it significantly reduces the frequency of GPS polling, potentially switching to less power-intensive location methods such as Wi-Fi or cellular network-based positioning. Conversely, when movement is detected, the location system 422 incrementally increases the update frequency to ensure accurate tracking. The rate of increase may be proportional to the speed of movement, with faster speeds triggering more frequent updates.

The location system 422 may also factor in additional contextual data when adjusting update frequencies. This data may include the device's battery level, with the user system 302 further reducing update frequencies as the battery level decreases to extend battery life. The application state is another consideration, with background operation requiring less frequent updates compared to when the application is in the foreground. The location system 422 may also temporarily increase update frequency when approaching known geofences or areas of interest to ensure timely triggering of location-based events or notifications.

To manage these different operational modes, the location system 422 may implement a state machine, allowing for smooth transitions between high-frequency and low-frequency update states based on the combination of detected conditions. This state machine approach provides fine-grained control over power consumption and ensures that the user system 302 can quickly adapt to changing user activities and environments.

At decision block 906, the digital interaction system 300 determines if the confidence level of the inferred location transgresses a predetermined threshold. If the confidence level is below the threshold, the method 900 returns to block 902 to continue monitoring the location. If the confidence level exceeds the threshold, the method 900 moves to block 908.

At decision block 908, the digital interaction system 300 may check if there is predetermined historical user activity on the map interface. This check may involve analyzing the user's past interactions with the map interface at similar locations.

At block 910, the digital interaction system 300 triggers an AI assistant (e.g., the AI chatbot 426 of the artificial intelligence and machine learning system 424) based on the inferred location and potentially the historical user activity. The triggering may involve invoking the prompt generator 432 to generate a prompt query, and sending a query to a language model (e.g., The Large Language Model (LLM) 434 and/or the Small Language Model (SLM) 436) that is specific to the geographic landmark.

At block 912, the artificial intelligence and machine learning system 424 generates AI-generated information (e.g., a summary of important historical information) about the geographic landmark. In some examples, if the geographic landmark is a venue such as a museum, the summary may include information about exhibits within the museum.

At block 914, the digital interaction system 300 causes display of a graphical indication of the AI-generated information (e.g., as an AI assistant icon 108) above a graphical representation of the user (e.g., user avatar 104) on a map interface (e.g., map interface 102). This display may involve an animated transition from a first state to a second state. In some examples, the first state may comprise an icon representing the AI assistant, and the second state may comprise the graphical indication including text, as described above with reference to FIG. 2

At decision block 916, the digital interaction system 300 enters a waiting state, anticipating user interaction with the displayed indication.

This waiting period is governed by a predetermined time threshold. If the user does not interact with the displayed indication within this set timeframe, the system takes a proactive approach by returning to block 902. This return to block 902 initiates a new cycle of location monitoring, ensuring that the system remains responsive to changes in the user's environment.

The user interaction with the displayed indication may take various forms, including tapping or clicking on the graphical indication (e.g., the AI assistant icon 108), expanding it to view additional information, or selecting specific interactive elements within the expanded view. For example, the user may tap on the AI assistant icon 108 to initiate the animated transition to the full summary text, or they may interact with interactive elements that allow them to request more specific information about the geographic landmark. Additionally, the user interaction could involve scrolling or zooming the map interface 102 while maintaining the relative position of the graphical indication above the user's graphical representation.

The predetermined waiting time serves as a balance between providing the user an opportunity to engage with the displayed information and maintaining system responsiveness. During this waiting period, the digital interaction system 300 may continue to monitor other aspects of user activity or device state in the background. If the waiting period elapses without user interaction, the digital interaction system 300 interprets this as a lack of immediate interest in the displayed information. By returning to the location monitoring state, the digital interaction system 300 can detect if the user has moved to a new location or if there are any changes in the surrounding environment that might warrant the generation of new, potentially more relevant information.

This cyclical process allows the digital interaction system 300 to maintain an up-to-date awareness of the user's context, ensuring that the information provided remains relevant and timely. It also helps in managing system resources efficiently by not persistently displaying information that the user may not be interested in at that moment.

At block 918, responsive to user selection of the displayed indication (e.g., the AI assistant icon 108), the digital interaction system 300 initiates a chat conversation with the AI assistant populated with the AI-generated information. This process involves transitioning from the map interface 102 to a chat interface 202 that is pre-populated with the AI-generated information about the geographic landmark. The chat interface 202 initializes a chat message session between the user of the user device and the AI chatbot 426, which becomes an active participant and contributor in the conversation.

The chat interface 202 displays the AI-generated landmark information 204, providing for example a summary of important details about the geographic landmark tailored to the user's location. The AI chatbot 426 may personalize this information based on the user's profile and historical interactions, prioritizing and highlighting relevant information that aligns with the user's preferences and interests.

The chat conversation functions as an interactive and dynamic dialogue between the user and the AI chatbot 426 within the context of a messaging session facilitated by the messaging system 410 and artificial intelligence and machine learning system 424. Users can ask further questions, seek clarifications, or request additional details about specific aspects of the landmark. The AI chatbot 426, leveraging natural language processing capabilities, engages in real-time conversation, providing comprehensive and contextually relevant responses based on the user's inquiries.

This chat session may further be expanded to include other users in the conversation. The digital interaction system 300 allows for other users in nearby proximity, for example as shown on the map interface 102, to join or be added to the chat session. This collaborative aspect enhances the social and interactive nature of the experience, allowing multiple users to engage with the AI chatbot 426 and share insights about the landmark simultaneously.

The chat interface 202 may send user messages via the messaging system 410 to the AI chatbot 426, which processes these inputs using the artificial intelligence and machine learning system 424. The AI chatbot 426 utilizes the prompt generator 432 and language models to generate responses based on its training data, the current context, and any additional information it can access about the landmark.

To generate the current event data 706, for example, the artificial intelligence and machine learning system 424 may employs Retrieval-Augmented Generation (RAG) or similar technologies. RAG combines the capabilities of large language models with the ability to retrieve relevant information from external knowledge sources. In this context, the AI chatbot 426 may use RAG to dynamically access and incorporate up-to-date information about the landmark, such as ongoing events, temporary exhibits, or recent historical discoveries.

The RAG process, in some examples, may involve several steps. When a user asks a question or the system needs to generate information about a landmark, a RAG system of the artificial intelligence and machine learning system 424 may queries a knowledge base (e.g., an entity table 504 for entity information about the geographic location) or external data sources to retrieve relevant information. This may include databases of historical facts, current event calendars, or real-time data feeds about the landmark. The retrieved information is then used to augment the input to the language model. This augmentation provides context and current information that may not have been part of the model's original training data.

Following the augmentation, the language model, such as the Large Language Model (LLM) 434 or the Small Language Model (SLM) 436, generates a response based on the augmented input. This allows the AI chatbot 426 to provide responses that are both contextually relevant and up-to-date. By utilizing RAG or similar technologies, the artificial intelligence and machine learning system 424 ensures that the current event data 706 is in fact current, enhancing the user experience by providing timely and accurate information about landmarks.

These responses are then displayed in the chat interface 202 as part of the ongoing conversation, allowing users to engage with current and historical information about the landmark in a dynamic and interactive manner. This approach enables the AI chatbot 426 to offer a comprehensive and informative interaction, combining its pre-trained knowledge with real-time data to provide users with a rich and current understanding of the landmarks they are exploring.

This interactive feature enables users to delve deeper into topics of interest, fostering engagement and a personalized learning experience. The chat interface 202 may also include options for users to save the information, share it through various platforms, or provide feedback on the content, enhancing overall user engagement with the historical and cultural information provided.

At block 920, the system may perform additional operations based on user preferences or system capabilities. These operations may include enabling sharing of the AI-generated summary through a digital interaction system 300, providing the AI-generated information in multiple selectable languages based on user preferences, using augmented reality to overlay the AI-generated summary on a display of the user system responsive to a user system camera being directed towards specific features of the geographic landmark, providing notifications to a user of the user system 302 responsive to the inferring of the location of the user system 302 being at the geographic location, or updating the AI-generated summary based on user interactions and feedback.

The method 900 may then return to block 902 to continue monitoring the user system 302's location and provide updated information as needed.

### Method 1000

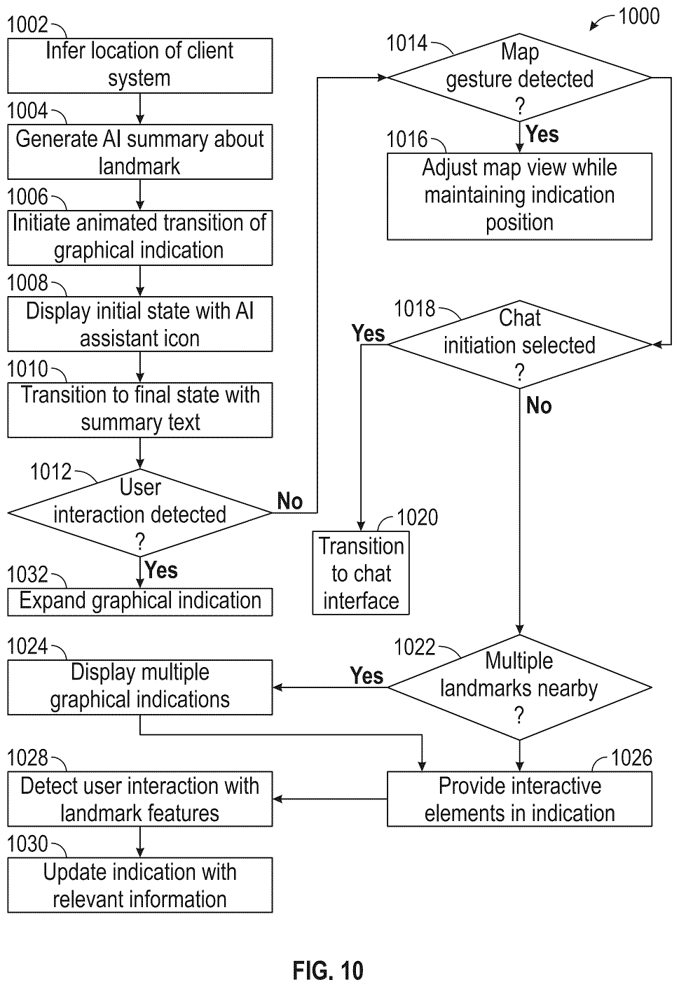

FIG. 10 is a flowchart illustrating a method 1000 for displaying AI-generated summaries about geographic landmarks on a map interface, according to some examples, of integrating location-based services with artificial intelligence assistants.

Although the example method depicted in FIG. 10 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 1002, the digital interaction system 300 automatically infers a location of a user system 302 at a geographic landmark based on location data. This inference may be performed using at least one processor and may involve analyzing data from multiple sensors of the user system 302, including GPS data and Wi-Fi triangulation data.

At block 1004, the digital interaction system 300 generates, via an AI assistant, a summary of information about the geographic landmark. The AI assistant may be triggered based on the inferred location and may use a query specific to the geographic landmark to generate the summary.

At block 1006, the digital interaction system 300 initiates an animated transition of a graphical indication of the AI-generated summary above a graphical representation of the user on a map interface. This operation involves creating a visually appealing and informative transition that draws the user's attention to the newly available information. The animated transition is designed to be smooth and engaging, using graphics rendering techniques to morph the initial icon into an expanded text bubble.

Referencing FIG. 2, the map interface 102 displays user avatars 104 representing the locations of different users. The AI assistant icon 108 is initially displayed near or adjacent (or otherwise in association with) the user avatars 104, signaling the availability of contextual information.

At block 1008, the system displays an initial state showing a graphical indication including an AI assistant icon 108 representing the AI assistant. This AI assistant icon 108 is positioned above the user's user avatar 104 on the map interface 102. In FIG. 2, this initial state is represented by the AI assistant icon 108 in its compact form, appearing as a simple icon near the user avatar 104.

The positioning of this AI assistant icon 108 is calculated based on the current map view, zoom level, and screen size. The digital interaction system 300 employs collision detection algorithms to ensure that the AI assistant icon 108 does not overlap with other important map elements or interfere with other user interface components.

At block 1010, the digital interaction system 300 transitions to a final state showing the graphical indication, including the text of the AI-generated summary. This transition involves a gradual expansion of the AI assistant icon 108 into a text bubble containing text of the AI-generated summary. In FIG. 2, this transition can be seen as the AI assistant icon 108 expands into a graphical indication that includes text or other visual elements.

The transition process may use a frame-by-frame rendering approach, where each intermediate state between the initial icon and the final expanded text bubble is calculated and displayed in succession. This creates the illusion of a fluid transition. The digital interaction system 300 may employ interpolation techniques, such as casing functions, to control the speed and acceleration of the animation, ensuring a natural and visually pleasing effect.

During this transition, the text of the AI-generated summary is dynamically loaded into the expanding bubble. The digital interaction system 300 may employ text-wrapping and truncation algorithms to ensure optimal readability within the confined space. For longer summaries, a scrolling mechanism may be implemented, allowing users to access additional content without overwhelming the initial view.

Throughout the animation process, the digital interaction system 300 continuously monitors user interactions, allowing for interruption or reversal of the animation if the user navigates away or performs other actions. This responsiveness ensures that the user maintains control over their interface experience at all times.

The final state, as shown in FIG. 2, displays the chat interface 202 presenting at least a portion of the AI-generated landmark information 204. This information provides, merely for example, a summary of important details about the geographic landmark.

At decision block 1014, if user interaction is detected, the system expands the graphical indication to display additional information from the AI-generated summary. This expansion process involves dynamically resizing and repositioning the graphical element on the map interface to accommodate the additional content.

The expansion may reveal a more comprehensive version of the AI-generated summary, potentially including historical facts, cultural significance, and other relevant details about the geographic landmark. The system employs text rendering algorithms to ensure the expanded content is legible and properly formatted within the enlarged graphical indication.

As part of this expansion, the digital interaction system 300 may display interactive elements that allow the user to request more specific information about the geographic landmark. These interactive elements could include:
1. Clickable tags or keywords related to different aspects of the landmark.
2. A scrollable interface for longer summaries or additional content sections.
3. Buttons or icons to initiate specific queries or actions, such as “Learn More” or “View Photos”.

The digital interaction system 300 may dynamically generate and position these interactive elements within the expanded graphical indication, ensuring they are easily accessible and responsive to user input.

To handle potential screen space limitations, especially on smaller devices, the digital interaction system 300 may implement adaptive layout algorithms. These algorithms adjust the size and position of the expanded graphical indication based on the available screen real estate, ensuring that critical map information remains visible while providing the additional AI-generated content.

At block 1016, the digital interaction system 300 checks if the user has performed a gesture to scroll or zoom the map interface. If such a gesture is detected, the system adjusts the map interface 102 while maintaining the relative position of the graphical indication above the user's graphical representation.

At decision block 1018, the digital interaction system 300 monitors for user selection of the graphical indication to initiate a chat conversation with the AI assistant. This monitoring process involves detecting specific user interactions, such as taps or clicks, on the expanded graphical indication that contains the AI-generated summary.

If the user selects the graphical indication, the digital interaction system 300 initiates a transition from the map interface 102 to the chat interface 202. This transition involves a seamless UI change, where the map view is replaced or overlaid with the chat interface.

The chat interface 202 is pre-populated with the AI-generated summary about the geographic landmark. This pre-population serves as a starting point for the conversation, providing the user with immediate context and information. The AI-generated landmark information 204 is displayed in the chat interface, offering a summary of important details about the geographic landmark, tailored to the user's location.

The transition to the chat interface also activates the AI chatbot 426, which becomes an active participant in the conversation. The chat interface 202 initializes a chat message session between the user and the AI chatbot 426, enabling an interactive and dynamic dialogue. Users can then engage with the pre-populated information, ask further questions, or seek additional details about the landmark.

This seamless transition from the map interface 102 to a pre-populated chat interface 202 enhances user engagement by providing a smooth flow from location-based information discovery to an interactive, AI-assisted learning experience about the geographic landmark.

At block 1020, the digital interaction system 300 detects proximity of the user's graphical representation to multiple geographic landmarks on the map interface 102. In response, the digital interaction system 300 may cause display of multiple graphical indications, each associated with a different geographic landmark.

This detection process may use geospatial analysis algorithms that continuously monitor the user's position relative to known landmark locations. The location system 422 may employ a spatial indexing structure, such as an R-tree or quadtree, to efficiently query and retrieve nearby landmarks as the user navigates the map interface 102. This approach allows for identification of relevant points of interest without the need for exhaustive searches across the entire dataset.

### The Proximity Detection Algorithm Considers Factors Such as:

The user's current location coordinates.
The zoom level of the map interface.
The density of landmarks in the current view
User movement speed and direction

Based on these factors, the location system 422 dynamically adjusts the radius within which landmarks are considered “proximate” to the user's graphical representation. This adaptive approach seeks to ensure that an appropriate number of landmarks are highlighted, regardless of whether the user is in a densely populated urban area or a more sparsely populated region.

Once proximate landmarks are identified, the digital interaction system 300 generates multiple graphical indications, each uniquely associated with a different geographic landmark. These graphical indications are rendered using vector graphics to ensure crisp display across various screen resolutions and zoom levels. The digital interaction system 300 employs a layout algorithm to position these indications optimally, avoiding overlap and ensuring visibility while maintaining their spatial relationship to the corresponding landmarks on the map.

At block 1022, the digital interaction system 300 monitors for user selection of one of the multiple graphical indications. If a selection is detected, the digital interaction system 300 prioritizes display of information related to the selected geographic landmark.

The monitoring process may use event listeners that capture user interactions such as taps, clicks, or hover actions on the graphical indications. These event listeners are optimized for performance, using techniques like event delegation to minimize memory usage and improve responsiveness, especially when dealing with a large number of interactive elements.

When a user selection is detected, the digital interaction system 300 may use a prioritization algorithm to reorganize the display of information. This algorithm may consider factors such as:
The selected landmark's relevance score
The user's historical interactions with similar landmarks.
The amount and quality of available information for the landmark
Current contextual factors (e.g., time of day, ongoing events)

### The Prioritization Process May Involve:

Visually emphasizing the selected graphical indication (e.g., through size increase, color change, or animation)
Reordering the display of multiple graphical indications to bring the selected one into focus.
Pre-fetching detailed information about the selected landmark to reduce latency in subsequent user interactions.
Adjusting the map view to ensure optimal visibility of the selected landmark and its associated information.

The digital interaction system 300 then initiates the process of retrieving and displaying more detailed information about the selected geographic landmark. This may involve querying the AI chatbot 426 for a more comprehensive summary, accessing cached data if available, or fetching real-time information from external sources using APIs or web services.

At block 1024, the digital interaction system 300 provides interactive elements within the graphical indication. These elements may allow the user to save the AI-generated summary, share it through a social media platform, provide feedback regarding the summary, or switch between different categories of information about the geographic landmark.

At block 1026, the digital interaction system 300 detects user interaction with specific features or exhibits within the geographic landmark. This detection process may involve analyzing the user's movement or gaze direction within the landmark. The digital interaction system 300 may use various sensors and technologies to achieve this, such as GPS data for outdoor positioning, Wi-Fi triangulation or Bluetooth beacons for indoor positioning, accelerometer and gyroscope data to detect user movement and orientation, camera input for visual recognition of exhibits or features, and augmented reality capabilities to track user's gaze direction.

The digital interaction system 300 used algorithms to process this sensor data in real-time, allowing it to accurately determine which specific features or exhibits the user is interacting with. This may involve techniques such as spatial mapping to create a digital representation of the landmark's layout, computer vision algorithms to recognize and identify specific exhibits or features, and machine learning models trained to interpret user behavior and predict areas of interest.

At block 1028, the digital interaction system 300 updates the graphical indication to display information relevant to the interacted features or exhibits. This update process may, for example, involve several operations. First, the digital interaction system 300 identifies the specific feature or exhibit the user is interacting with based on the detection in block 1026. It then queries the artificial intelligence and machine learning system 424 for more specific information about the particular feature or exhibit, using the prompt generator 432. This query created by the prompt generator 432 may include the unique identifier of the feature/exhibit, the user's current context (e.g., time spent at the exhibit, previous interactions), and any relevant user preferences or history.

The artificial intelligence and machine learning system 424 processes the query using its knowledge base (e.g., the Large Language Model (LLM) 434) and generates a tailored response. This may involve retrieving pre-stored information about the exhibit, dynamically generating a summary using natural language processing techniques, and incorporating real-time data if available (e.g., current status of an interactive exhibit).

The digital interaction system 300 then updates the graphical indication with the new information. This update may include replacing the existing content with new, more relevant information, expanding the graphical indication to show additional details, or adding interactive elements specific to the feature/exhibit (e.g., audio guides, 3D models). The updated graphical indication is rendered on the user device (e.g., by the interaction client 304).

This dynamic updating process allows the digital interaction system 300 to provide highly contextual and relevant information to users as they explore different aspects of a geographic landmark, enhancing their educational experience and engagement with the surroundings.

The method 1000 may then return to block 1002 to continue monitoring the user system 302 location and provide updated information as needed.

### Method 1100

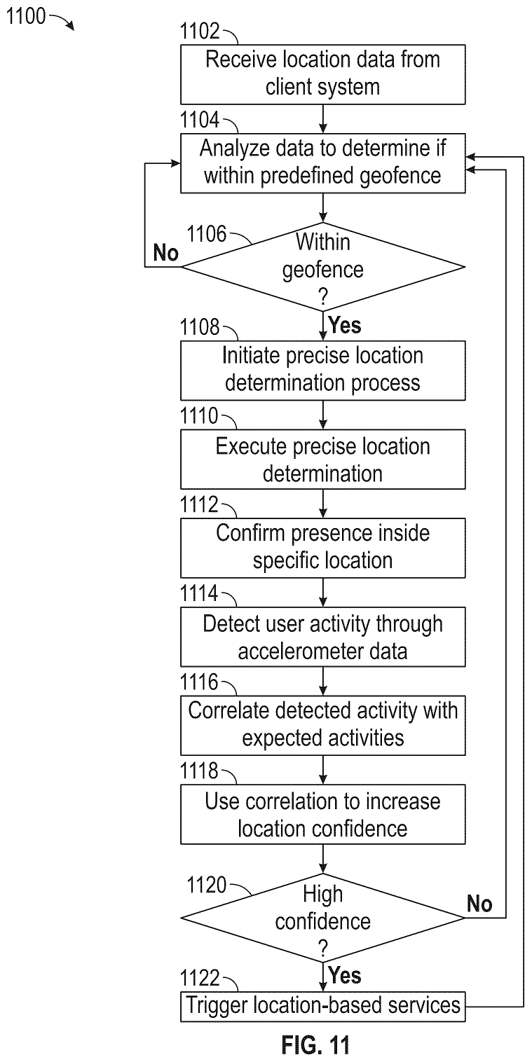

FIG. 11 is a flowchart illustrating a method 1100 for precise location determination and triggering of location-based services, according to some examples, of enhancing geolocation accuracy for a user system 302 within specific geographic locations.

Although the example method depicted in FIG. 11 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 1102, the location system 422 receives location data from a user system 302. This operation may be performed by at least one processor, which may be part of a server system or integrated within the user system 302 itself. The location data may include GPS coordinates, Wi-Fi signal strengths, cellular tower information, or other relevant location-related data.

At block 1104, the location system 422 analyzes the received location data to determine if the user system 302 is located within a predefined geofence corresponding to a specific geographic location. This analysis may involve comparing the received coordinates with a database of geofence boundaries. In some examples, the geofence may be defined as a virtual perimeter around a physical location, such as a museum, landmark, or other point or venue of interest.

At block 1106, if the location system 422 determines that the user system 302 is within the predetermined geofence may include more intensive location tracking methods to confirm the exact position of the user system 302 within the geofence.

The precise location determination process, executed at block 1108 by the location system 422, may use a combination of technologies to achieve higher accuracy. This may include Wi-Fi triangulation, which measures signal strengths from multiple Wi-Fi access points to calculate the user's position. The location system 422 may also analyze Bluetooth beacon signals, leveraging d beacons within the geographic location to pinpoint the user's exact coordinates. For indoor environments, the location system 422 may employ specialized indoor positioning systems that use a combination of technologies such as ultra-wideband (UWB) signals, magnetic field mapping, or visual positioning using the device's camera.

In addition to these methods, the location system 422 may collect and analyze additional sensor data from the user system 302. This may include data from the device's accelerometer, gyroscope, and magnetometer. By fusing data from multiple sensors, the location system 422 can create a more accurate picture of the user's movement and orientation within the space. This sensor fusion approach helps compensate for the limitations of individual positioning technologies and provides a more robust location estimate.

At block 1110, the system uses the results of the precise location determination process to confirm the presence of the user system 302 inside the specific geographic location. This confirmation may involve, merely for example, cross-referencing the refined location data with detailed floor plans or 3D models of the location. The location system 422 may use spatial mapping techniques to match the user's position to specific features or landmarks within the environment.

This cross-referencing process may also involve techniques such as particle filtering or Kalman filtering to integrate the various sources of location data and reduce uncertainty. The location system 422 may compare the user's estimated position against known reference points within the 3D model or floor plan, adjusting for discrepancies and refining the location estimate. This process not only confirms the user's presence within the specific geographic location but also provides context for their exact position relative to specific exhibits, rooms, or features of interest.

At block 1112, the system detects user activity through accelerometer data from the user system 302. This may involve analyzing patterns in the accelerometer readings to infer specific types of movement or actions.

At block 1114, the location system 422 correlates the detected user activity with expected activities within the specific building or site. For example, if the location is a museum, the digital interaction system 300 may look for patterns of movement consistent with viewing exhibits. This correlation process may involve comparing the detected activities with a database of expected behaviors for different types of locations.

At block 1116, the location system 422 uses the correlation between detected and expected activities to increase confidence in the determined presence of the user system 302 inside the specific building or site. This operation may add an additional layer of verification to the location determination process.

At block 1118, if the presence of the user system 302 is confirmed with high confidence, the digital interaction system 300 triggers location-based services associated with the specific geographic location. These services may include providing AI-generated information about landmarks, offering interactive guides, or enabling augmented reality features specific to the location.

The method 1100 may then loop back to block 1102 to continue monitoring the location of the user system 302, allowing for real-time updates and seamless transitions between different geographic locations.

### Method 1200

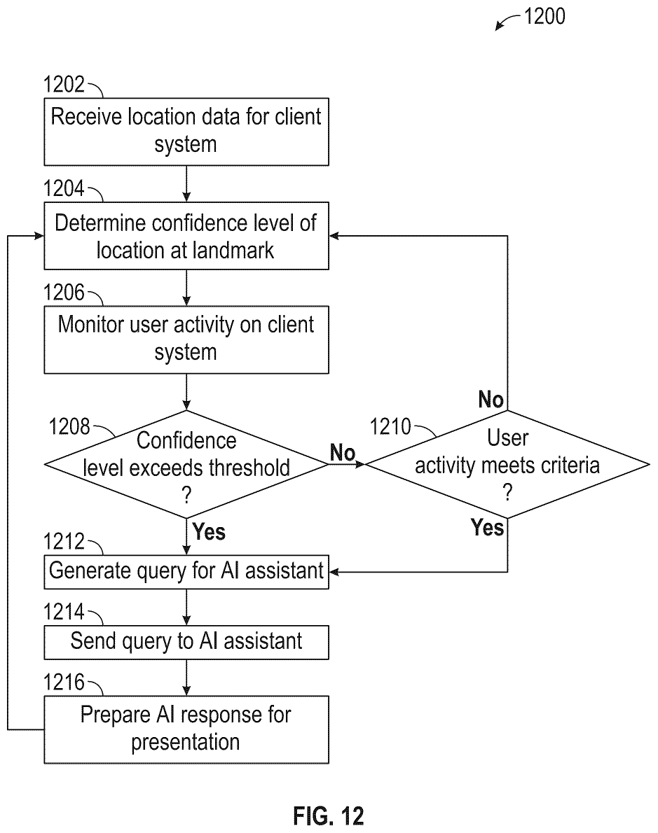

FIG. 12 is a flowchart illustrating a method 1200 for determining when to query an AI assistant for information about a geographic landmark, according to some examples, of optimizing location-based services and AI interactions.

Although the example method depicted in FIG. 12 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 1202, the location system 422 receives location data for a user system 302. This operation may be performed by at least one processor, which may be part of a server system or integrated within the user system 302 itself. The location data may include GPS coordinates, Wi-Fi signal strengths, cellular tower information, or other relevant location-related data.

At block 1204, the location system 422 determines a confidence level that the user system 302 is located at a geographic landmark based on the received location data. This determination may involve comparing the received coordinates with a database of known landmark locations and calculating a probability based on the proximity and accuracy of the location data.

At block 1206, the location system 422 monitors user activity on the user system 302. This monitoring process involves tracking various user interactions with the user system 302 and the interaction client 304, including the opening of specific applications, viewing of certain content, and engagement with map interfaces. The location system 422 may also analyze accelerometer data to infer user movement patterns, providing additional context about the user's behavior and potential interest in nearby landmarks.

At decision block 1208, the location system 422 determines whether to query an AI assistant for information about the geographic landmark. In some examples, the decision-making process is based on two criteria: the confidence level of the user's location and the nature of the monitored user activity. The location system 422 may employ an algorithm that weighs these factors to determine the appropriate time to initiate an AI query.

At decision block 1210, the location system 422 evaluates whether the confidence level of the user's location exceeds a predetermined threshold. This threshold is likely set based on factors such as the accuracy of the location data and the proximity to known landmarks. If the confidence level surpasses this threshold, indicating a high probability that the user is at or near a specific landmark, the process advances to block 1214.

If the confidence level does not meet the threshold, the method 1200 moves to block 1212. Here, the location system 422 assesses whether the monitored user activity aligns with predefined activity criteria. These criteria may include actions that suggest the user's interest in their surroundings, such as active use of a map application, searches for information about nearby landmarks, or movement patterns indicative of exploration. This operating system 1802 allows the location system 422 to identify potential interest in landmark information even when location confidence is lower.

At block 1214, if either the location confidence is high or the user activity meets the criteria, the location system 422 generates a query for the AI assistant. This query is tailored to request information about the relevant geographic landmark. The artificial intelligence and machine learning system 424 may customize this query based on several factors, including the specific characteristics of the landmark, the user's known preferences, and data from their historical interactions. This tailoring process ensures that the AI-generated information is relevant and engaging to the user.

At block 1216, the AI chatbot 426 sends the generated query to the Large Language Model (LLM) 434 or the Small Language Model (SLM) 436 and awaits a response. The artificial intelligence and machine learning system 424 may process the query using natural language processing techniques and access relevant databases to compile information about the landmark.

At block 1318, upon receiving the AI assistant's response, the digital interaction system 300 may prepare the information for presentation to the user. This may involve formatting the content for display within a map interface 102, generating a notification, or preparing an interactive element for user engagement.

The method 1200 may then loop back to block 1202 to continue monitoring the user system 302's location and user activity, allowing for real-time updates and seamless transitions between different geographic locations.

### Method 1300

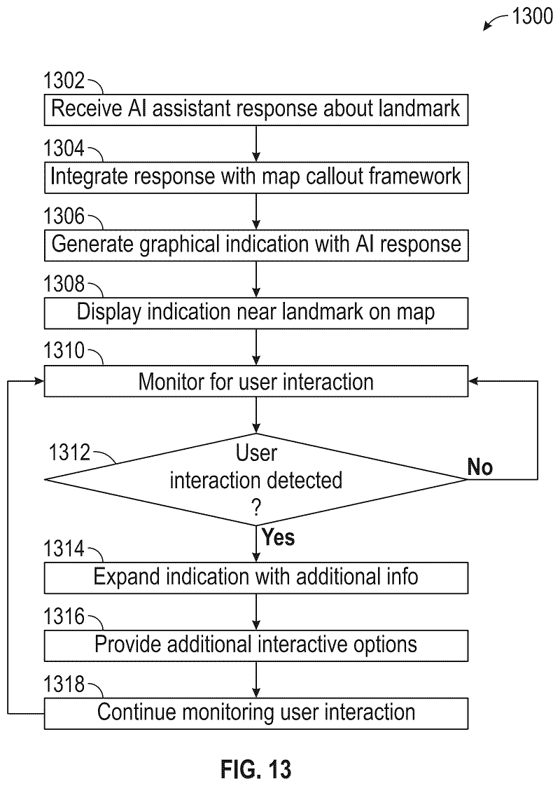

FIG. 13 is a flowchart illustrating a method 1300 for integrating AI assistant responses with a map interface, according to some examples, of enhancing user interaction with geographic landmark information.

Although the example method depicted in FIG. 13 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 1302, the digital interaction system 300 receives, by at least one processor, a response from an AI assistant regarding a geographic landmark. This response may be generated based on a query sent to the AI assistant, which may have been triggered by the user's proximity to the landmark or specific user interactions.

At block 1304, the digital interaction system 300 integrates the AI assistant response with an existing map callout framework of a map interface. This integration process may involve parsing the AI response and formatting it to fit within the established structure of map callouts. The existing framework may include predefined templates for displaying information about various types of landmarks.

At block 1306, the digital interaction system 300 generates a graphical indication incorporating the AI assistant response. This graphical indication may take the form of an icon, a text bubble, or a combination of visual elements designed to attract the user's attention without overwhelming the map interface. In some examples, the graphical indication may include an animated transition between different states to enhance visibility.

At block 1308, the digital interaction system 300 causes display of the graphical indication proximate to a representation of the geographic landmark on the map interface. The placement of this indication may be optimized to avoid obscuring other important map elements while maintaining a clear association with the specific landmark it describes.

At block 1310, the digital interaction system 300 monitors user interaction with the graphical indication. This may include detecting various types of user input such as taps, clicks, or hover actions, depending on the device and interface capabilities.

At block 1312, responsive to detecting user interaction with the graphical indication, the digital interaction system 300 expands the graphical indication to reveal additional information from the AI assistant response. This expansion may involve a smooth animation that transforms the initial compact indication into a more comprehensive display. The expanded view may include more detailed text, images, or interactive elements that provide a richer context about the landmark.

At block 1314, the digital interaction system 300 may provide additional interactive options within the expanded graphical indication. These options may include the ability to initiate a chat conversation with the AI assistant for more specific queries, share the information through social media platforms, or save the landmark details for future reference.

At block 1316, the digital interaction system 300 continues to monitor user interaction with the expanded graphical indication and the surrounding map interface. This ongoing monitoring allows the digital interaction system 300 to respond to further user actions, such as closing the expanded view, interacting with other map elements, or requesting more information about the landmark.

The method 1300 may then loop back to block 1302 or another appropriate block based on subsequent user actions or changes in the user's location, ensuring a dynamic and responsive user experience.

### Method 1400

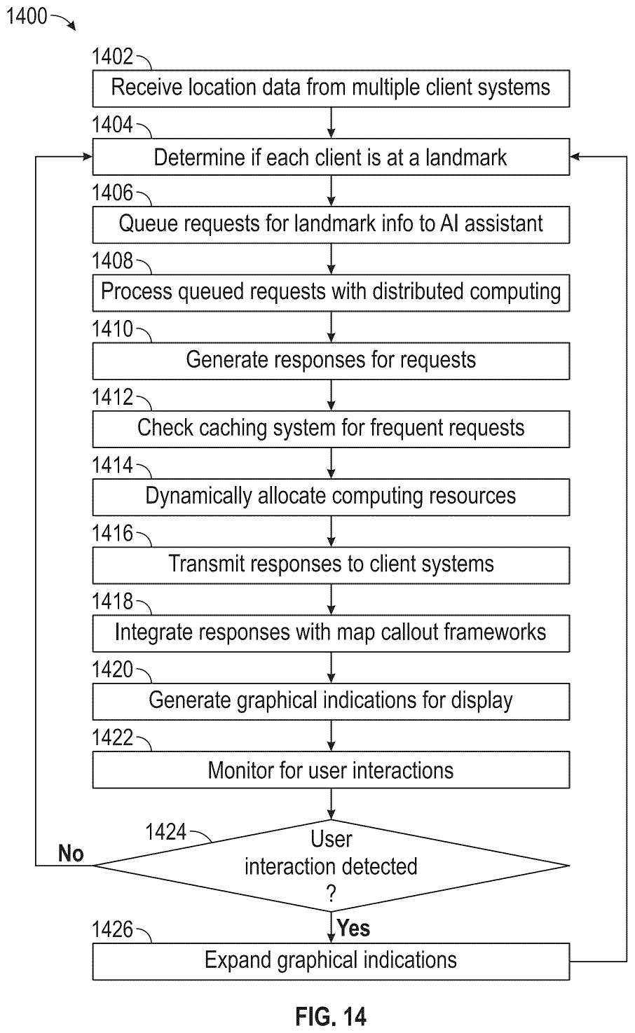

FIG. 14 is a flowchart illustrating a method 1400 for processing and distributing AI-generated information about geographic landmarks to multiple user systems 302, according to some examples.

Although the example method depicted in FIG. 14 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 1402, the digital interaction system 300 receives, by at least one processor, location data from a plurality of user systems 302 across different geographical locations. This location data may include GPS coordinates, Wi-Fi signal strengths, cellular tower information, or other relevant location-related data.

At block 1404, the digital interaction system 300 determines, for each user system 302, whether the user system 302 is at a geographic landmark. This determination may involve comparing the received coordinates with a database of known landmark locations and calculating a probability based on the proximity and accuracy of the location data.

At block 1406, the digital interaction system 300 queues requests to the AI assistant for information about geographic landmarks where user systems 302 are determined to be located. This queuing process may, in some examples, be implemented by the messaging system 410, which manages the flow of requests to the artificial intelligence and machine learning system 424.

The messaging system 410 may prioritize these requests based on several factors including for example:
User activity levels: More active users may receive higher priority in the queue.
Subscription status: Users with premium subscriptions might get preferential treatment.
Time sensitivity of the requested information: Requests for information about time-limited events or exhibits could be given higher priority.

The messaging system 410 may further employ queue management algorithms to efficiently handle and prioritize these requests. This may involve techniques such as priority queues or multi-level feedback queues to ensure that high-priority requests are processed more quickly while still maintaining fair processing for all users.

At block 1408, the digital interaction system 300 processes the queued requests using a distributed computing architecture to handle concurrent requests efficiently. This approach allows the system to scale and manage high volumes of simultaneous user interactions across different geographical locations.

A load balancing system may distribute incoming requests across multiple server instances. This distribution may be based on multiple factors including for example:
Current server load: The system monitors the processing capacity and current workload of each server instance, directing new requests to less burdened servers to maintain optimal performance.
Geographical proximity: Requests are routed to server instances that are geographically closer to the requesting user systems 302. This reduces latency and improves response times for users.

The load balancing system may make real-time decisions on request routing. Algorithms may consider factors such as server health, network conditions, and request characteristics to optimize the distribution of workload across the server infrastructure. The distributed architecture and load balancing approach enables the digital interaction system 300 to handle a large number of concurrent requests efficiently, ensuring responsive and timely delivery of AI-generated information about geographic landmarks to users across various locations.

At block 1410, the digital interaction system 300 generates responses for the processed requests. This process may utilize parallel processing techniques to generate multiple responses simultaneously, enhancing efficiency and reducing overall response time.

At block 1412, the digital interaction system 300 implements a caching system to store frequently requested information about popular geographic landmarks. Before querying the AI assistant (e.g., the AI chatbot 426), the digital interaction system 300 checks the caching system to reduce processing load and improve response times.

The caching system may, in some examples, be integrated with the messaging system 410 and the artificial intelligence and machine learning system 424 to optimize the retrieval and storage of landmark information. The messaging system 410 acts as an intermediary, managing the flow of requests between the user systems 302 and the caching system.

When a request for landmark information is received, the messaging system 410 first checks the caching system. If the requested information is found and valid, it is returned to the user via the messaging system 410, bypassing the need to query the artificial intelligence and machine learning system 424.

If the information is not found in the cache or has expired, the messaging system 410 forwards the request to the artificial intelligence and machine learning system 424. This system, which includes components such as the AI chatbot 426, prompt generator 432, and language models (LLM 434 and SLM 436), processes the request to generate the required landmark information.

The artificial intelligence and machine learning system 424 may employ techniques such as:
Natural Language Processing (NLP) to interpret and generate human-like responses about landmarks.
Machine Learning algorithms to continuously improve the relevance and accuracy of the generated information based on user interactions and feedback.
Knowledge Graph technologies to efficiently organize and retrieve complex relationships between different aspects of landmarks.

Once the artificial intelligence and machine learning system 424 generates the response, it is sent back through the messaging system 410 as part of an interactive chat or messaging session between the AI chatbot 426 and a user of the relevant user system 302. Before delivering the response to the user, the messaging system 410 updates the caching system with the new data. This ensures that subsequent requests for the same information can be served directly from the cache.

The caching system may implement intelligent caching strategies in collaboration with the artificial intelligence and machine learning system 424. For example:
Predictive caching: The artificial intelligence and machine learning system 424 may analyze patterns in user requests and preemptively cache information about landmarks that are likely to be queried soon.
Contextual caching: The system may cache different versions of landmark information based on user contexts (e.g., time of day, user preferences) as determined by the artificial intelligence and machine learning system 424.
Dynamic TTL (Time-To-Live): The artificial intelligence and machine learning system 424 may adjust the expiration time of cached items based on the likelihood of information changes for different types of landmarks.

This integrated approach allows the digital interaction system 300 to leverage the power of AI for generating high-quality, contextually relevant landmark information while using caching to optimize performance and reduce load on the artificial intelligence and machine learning system 424.

At block 1414, the digital interaction system 300 dynamically allocates computing resources based on real-time demand across different geographical regions. This may involve monitoring system performance metrics in real-time and automatically scaling computing resources to maintain response times below a predetermined threshold.

At block 1416, the digital interaction system 300 transmits the generated responses to the respective user systems 302. This transmission process may use a content delivery network (CDN) to efficiently distribute generated responses to user system 302s across different geographical locations.

The transmission process leverages the communication system 408 within the digital interaction system 300 to manage the delivery of responses. The content delivery network (CDN) used in this process may comprise of a distributed network of servers strategically located in different geographic regions. This network architecture allows the system to serve content from servers that are physically closer to the end-users, reducing latency and improving response times. The CDN may implement one or more of the following techniques:
Edge caching: Popular responses are cached at edge servers, allowing for faster retrieval for subsequent requests from users in the same region.
Dynamic content acceleration: For responses that cannot be fully cached (e.g., personalized AI-generated content), the CDN may optimize the delivery path and use techniques like TCP optimization and compression to speed up transmission.
Intelligent routing: The CDN may use real-time network analytics to determine the most efficient path for each response, considering factors such as network congestion and server load.
Adaptive bitrate streaming: For multimedia content related to landmarks, the CDN may adjust the quality of the content based on the user's network conditions to ensure smooth delivery.
Geographic load balancing: The system distributes requests across multiple data centers to prevent overload and ensure high availability.

The digital interaction system 300 may also implement a push-based update mechanism, where certain types of landmark information are proactively pushed to edge servers or even to user systems 302 based on predictions made by the artificial intelligence and machine learning system 424. This approach can further reduce latency for frequently accessed information.

At block 1418, the digital interaction system 300 integrates the AI assistant responses with existing map callout frameworks of map interfaces on the user system 302s. This integration process may include parsing the AI responses and formatting them to fit within the established structure of map callouts on the map interface 102. The digital interaction system 300 may use natural language processing techniques to extract key information from the AI-generated responses and adapt it to the constraints of the map interface.

### The Integration Process May Include for Example:

Parsing the AI response to extract key information.
Formatting the extracted information to fit within predefined size constraints of the map callout framework.
Adapting the content to different zoom levels of the map interface, providing varying levels of detail based on the current zoom level.
Ensuring compatibility with the existing visual design and interaction patterns of the map interface.

At block 1420, the digital interaction system 300 generates graphical indications incorporating the AI-generated summaries for display on the user systems 302. These graphical indications may take various forms, including icons, text bubbles, or combinations of visual elements designed to attract user attention without overwhelming the map interface.

The Generation of these Graphical Indications May Include:
Creating vector graphics to ensure clear display across various screen resolutions and zoom levels.
Implementing a layout algorithm to position these indications optimally, avoiding overlap and ensuring visibility while maintaining their spatial relationship to the corresponding landmarks on the map.
Displaying interactive elements that allow users to expand or collapse the displayed information.
Incorporating animations or transitions to smoothly reveal or hide the AI-generated content.

The digital interaction system 300 may employ techniques such as progressive disclosure, where initial graphical indications provide a brief summary, with options for users to access more detailed information through interaction. This approach helps balance information density with user experience on the map interface.

Additionally, the digital interaction system 300 may implement a prioritization algorithm to determine which graphical indications to display when multiple landmarks are in close proximity. This algorithm could consider factors such as the relevance of the landmark to the user's interests, the quality and quantity of available information, and the current context (e.g., time of day, user's recent interactions).

At block 1422, the digital interaction system 300 monitors for user interactions with the graphical indications on the user systems 302. This may include detecting user gestures such as taps, clicks, or swipes on the map interfaces.

At decision block 1424, if user interaction is detected, the digital interaction system 300 expands the graphical indications to display additional information from the AI-generated summaries. This expansion may include displaying interactive elements allowing users to request more specific information about the geographic landmarks.

The method 1400 may then return to block 1402 to continue monitoring the user system 302s′ locations and provide updated information as needed, allowing for real-time updates and seamless transitions between different geographic locations.

### Method 1500

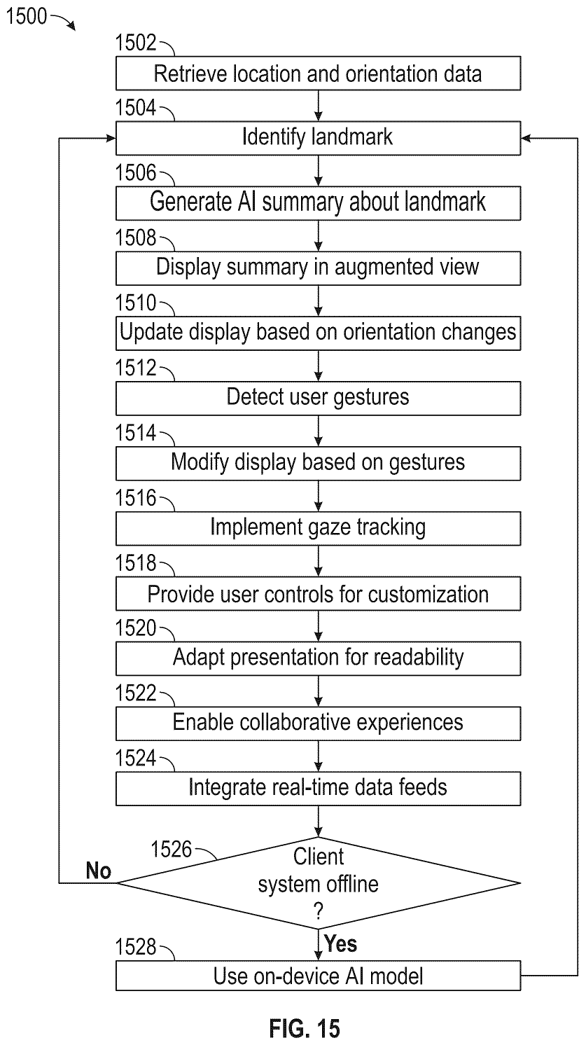

FIG. 15 is a flowchart illustrating a method 1500 for providing augmented reality experiences with AI-generated information about geographic landmarks, according to some examples, of enhancing user interaction with physical environments through advanced mobile and wearable technologies.

Although the example method depicted in FIG. 15 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 1502, the digital interaction system 300 retrieves location data and orientation data from a user system 302. The location data may include GPS coordinates, while orientation data may be obtained from the device's gyroscope and compass. In some examples, the user system 302 may be a smartphone or augmented reality spectacles.

At block 1504, digital interaction system 300 identifies the geographic landmark based on the location and orientation data. This identification process may involve comparing the user system 302's position and viewing direction with a database (e.g., storing the entity table 504) of known landmark locations. Computer vision techniques may be employed to recognize specific visual features of the landmark for more precise identification.

At block 1506, the digital interaction system 300 generates, via the artificial intelligence and machine learning system 424, a summary of information about the identified geographic landmark. This generation process may involve accessing databases containing historical, cultural, and architectural information about various landmarks. The artificial intelligence and machine learning system 424 may use natural language processing techniques to synthesize this information into concise, informative summaries.

At block 1508, the digital interaction system 300 displays the AI-generated summary in an augmented view on the user system 302. This display process may involve anchoring the summary to specific visual features of the geographic landmark using computer vision techniques. The digital interaction system 300 may use depth-sensing capabilities of the user system 302 to accurately position the summary in three-dimensional space relative to the geographic landmark.

In some examples, the augmented view may be generated on a mobile device 314 using video see-through AR. This approach involves capturing the real-world environment through the device's camera and overlaying digital content on the video feed in real-time. The digital interaction system 300 may use techniques such as simultaneous localization and mapping (SLAM) to track the device's position and orientation relative to the environment. Computer vision algorithms can be employed to detect and track specific features of the landmark, allowing the AI-generated summary to be anchored to these features in the video feed.

For the wearable apparatus 316, the augmented view may be generated using optical see-through AR. This method utilizes transparent displays, such as those in the image display of optical assembly 1604, to overlay digital content directly onto the user's view of the real world. The digital interaction system 300 may leverage the wearable apparatus 316's sensors, including the visible light camera 1606, infrared emitter 1608, and infrared camera 1610, to accurately track the user's position and gaze direction. This information, combined with spatial mapping of the environment, allows the system to render the AI-generated summary in the correct position relative to the geographic landmark.

At block 1510, the digital interaction system 300 updates the displayed summary in real-time in response to orientation changes of the user system 302. This may involve using the device's sensors to detect movement and adjusting the position and orientation of the displayed information accordingly.

For the mobile device 314, this real-time updating process may use data from the device's accelerometer, gyroscope, and magnetometer to detect changes in orientation and position. The digital interaction system 300 can then adjust the rendering of the augmented content to maintain its perceived position relative to the real-world landmark.

In the case of the wearable apparatus 316, the digital interaction system 300 may use the device's built-in sensors, such as those in the low-power circuitry 1612, to detect head movements and orientation changes. The image display driver 1614 can then update the rendering of the AI-generated summary on the image display of optical assembly 1604 to maintain proper alignment with the user's view of the geographic landmark.

At block 1512, the digital interaction system 300 detects user gestures via the user system 302. These gestures may include hand movements, finger taps, or eye movements, depending on the capabilities of the user system 302. For the mobile device 314, this may involve detecting touch gestures on the screen or motion gestures captured by the device's sensors. In the case of the wearable apparatus 316, the digital interaction system 300 may use the user input device 1616 (e.g., touch sensor or push button) to detect user interactions, or employ more advanced techniques such as eye-tracking using the infrared camera 1610.

At block 1514, the digital interaction system 300 modifies the display of the summary based on the detected gestures. This modification process is designed to enhance user interaction with the AI-generated content. The digital interaction system 300 may implement various response mechanisms depending on the type of gesture detected:
Zooming in on specific information: When a user performs a pinch-to-zoom gesture or a similar interaction, the wearable apparatus 316 may enlarge portions of the AI-generated summary, providing more detailed information about a particular aspect of the landmark.
Revealing additional details: Certain gestures, such as tapping on specific elements of the summary, may trigger the display of expanded information. This may involve showing additional text, images, or even multimedia content related to the selected aspect of the landmark.
Navigating through different aspects of the AI-generated summary: Swipe gestures or other directional inputs might allow users to cycle through different categories of information about the landmark, such as historical facts, architectural details, or cultural significance.

For the wearable apparatus 316, these modifications may be rendered in real-time on the image display of optical assembly 1604, with the image display driver 1614 adjusting the content based on the detected gestures. The system may employ the image Processor 1618 to ensure smooth transitions and maintain proper alignment with the user's view of the real-world environment.

The digital interaction system 300 may use gesture recognition algorithms and machine learning models to accurately interpret user intentions and provide appropriate responses. This dynamic interaction allows users to explore the AI-generated content in a more intuitive and engaging manner, enhancing their overall experience with the geographic landmark information.

At block 1516, the digital interaction system 300 implements gaze tracking to determine which part of the geographic landmark the user is focusing on and adjusts the displayed summary accordingly. This feature may be implemented using the wearable apparatus 316, which includes specialized components for precise eye tracking. The infrared emitter 1608 and infrared camera 1610 may work together to track the user's eye movements with high accuracy.

Once the user's gaze is determined, the digital interaction system 300 correlates this information with the known spatial layout of the geographic landmark. This process may involve mapping the user's gaze vector onto a 3D model of the landmark stored in the system's database, using computer vision techniques to identify specific features or elements of the landmark that intersect with the gaze vector, and employing machine learning models trained on landmark features to accurately interpret which specific aspect of the landmark the user is focusing on.

Based on this analysis, the digital interaction system 300 adjusts the displayed summary to prioritize information relevant to the user's current focus. This adjustment may include reordering the content of the AI-generated summary to bring information about the observed feature to the forefront, expanding details about the specific element the user is looking at while condensing other information, and triggering the retrieval of additional, more specific information about the observed feature from the AI assistant.

The image display driver 1614 of the wearable apparatus 316 dynamically updates the displayed information on the image display of optical assembly 1604.

At block 1518, digital interaction system 300 provides user controls to customize the display of the AI-generated summary in the augmented view. These controls may allow users to adjust the size, position, or level of detail of the displayed information.

At block 1520, digital interaction system 300 adapts the presentation of the AI-generated summary to optimize readability and user experience. This may include adjusting the transparency of the displayed summary based on environmental lighting conditions.

At block 1522, the digital interaction system 300 enables collaborative experiences where multiple user systems 302 can view and interact with the same AI-generated summaries. This collaborative functionality can be implemented across different types of devices, including mobile devices 314 using video see-through AR and wearable apparatus 316 using optical sec-through AR.

For mobile devices 314 utilizing video see-through AR, the augmented view may be generated by capturing the real-world environment through the device's camera and overlaying digital content on the video feed in real-time. The mobile device 314 may employ computer vision algorithms to detect and track specific features of the landmark, allowing the AI-generated summary to be anchored to these features in the video feed. This approach enables multiple users with mobile devices to view the same AI-generated content overlaid on their respective camera feeds, creating a shared augmented experience.

In the case of the wearable apparatus 316 using optical see-through AR, the augmented view is generated using transparent displays in the image display of optical assembly 1604. This method overlays digital content directly onto the user's view of the real world. The wearable apparatus 316 utilizes its sensors, including the visible light camera 1606, infrared emitter 1608, and infrared camera 1610, to accurately track the user's position and gaze direction. This information, combined with spatial mapping of the environment, allows the system to render the AI-generated summary in the correct position relative to the geographic landmark for each user wearing the apparatus.

To enable collaborative experiences, the digital interaction system 300 synchronizes the augmented view across different devices in real-time. This synchronization process may include for example:
Establishing a shared coordinate system: The digital interaction system 300 creates a common reference frame for all participating devices, ensuring that the AI-generated content is positioned consistently relative to the real-world landmark for all users.
Real-time data exchange: The digital interaction system 300 implements low-latency communication protocols to share user interactions and content updates across all connected user systems 302.
Conflict resolution: When multiple users interact with the AI-generated summaries simultaneously using user systems 302, the digital interaction system 300 employs algorithms to resolve conflicts and maintain a consistent view for all participants.
Adaptive rendering: The digital interaction system 300 may adjust viewing perspectives, ensuring an optimal experience for both mobile and wearable AR users.

At block 1524, the digital interaction system 300 integrates real-time data feeds to enhance the AI-generated summaries with current information about the geographic landmark. This integration process may leverage the current event data 706, which includes information about ongoing events, activities, or other dynamic content relevant to the user's location.

The digital interaction system 300 may further use a combination of techniques to gather and incorporate this real-time information, including for example:
API Integration: The digital interaction system 300 may connect to various external APIs to fetch up-to-date information. For instance, it might interface with weather service APIs to provide current weather conditions at the landmark, or with event management platforms to retrieve information about ongoing or upcoming events.
Web Scraping: For landmarks or museums that regularly update their websites with current information, the digital interaction system 300 may use web scraping techniques to extract relevant data in real-time.
User-Generated Content: The digital interaction system 300 may incorporate recent user reviews, ratings, or social media posts related to the landmark to provide a more dynamic and current perspective.
IoT Sensors: For some landmarks, the digital interaction system 300, via user systems 302, may access data from Internet of Things (IoT) sensors installed on-site, providing real-time information about visitor numbers, queue lengths, or environmental conditions.

At block 1526, the digital interaction system 300 checks if the user system 302 is offline. If offline, the digital interaction system 300 may use an on-device AI model to generate summaries about geographic landmarks. This on-device model may be a compressed version of the main AI assistant, capable of providing basic information without requiring an internet connection.

As an example, the artificial intelligence and machine learning system 424 of the digital interaction system 300 may use the Small Language Model (SLM) 436, which is designed to operate on local devices, providing quick and responsive language processing capabilities even when the user system 302 is offline or has limited connectivity.

The Small Language Model (SLM) 436 may be optimized for performance and efficiency, making it suitable for real-time applications where low latency is critical. This on-device model ensures that users can still access essential AI functionalities without relying solely on server-based resources. When offline, the Small Language Model (SLM) 436 can process user queries and generate summaries about geographic landmarks using its compressed knowledge base, which includes key information about popular landmarks and points of interest.

At block 1528, the digital interaction system 300 uses the augmented view to visualize historical or future states of the geographic landmark based on the AI-generated summary. This visualization process involves, merely for example, overlaying 3D models or animations onto the user's view of the real-world environment, leveraging different technologies for mobile devices 314 and wearable apparatus 316.

For mobile devices 314, the digital interaction system 300 may use video see-through AR techniques. The communication system 408 facilitates the retrieval and transmission of 3D models or animations representing historical or future states of the landmark. The messaging system 410 manages the flow of this data, ensuring efficient delivery to the user's device. The video communication system 412 then processes this visual content, integrating it with the real-time video feed from the device's camera to create a seamless augmented experience.

In the case of the wearable apparatus 316, the digital interaction system 300 may employ optical see-through AR. The image display of optical assembly 1604 overlays the 3D models or animations directly onto the user's view of the real world. The audio communication system 416 may provide synchronized audio narration or sound effects to enhance the immersive experience of visualizing different time periods or future scenarios.

The artificial intelligence and machine learning system 424 may assist in generating and adapting these visualizations. For example, the 424 may process the AI-generated summary to determine key historical events or potential future developments that can be visually represented. The digital interaction system 300 may use machine learning algorithms to reconstruct historical appearances of landmarks based on available data or to project future states based on current plans or trends.

For both mobile devices and wearable apparatus, the digital interaction system 300 ensures that the visualizations are accurately positioned and scaled relative to the real-world landmark. This may involve using computer vision techniques to track specific features of the landmark and anchor the 3D models or animations to these points.

The method 1500 may then loop back to block 1502 to continue monitoring the user system 302's location and orientation, allowing for real-time updates and seamless transitions between different geographic landmarks.

### Wearable Apparatus 316

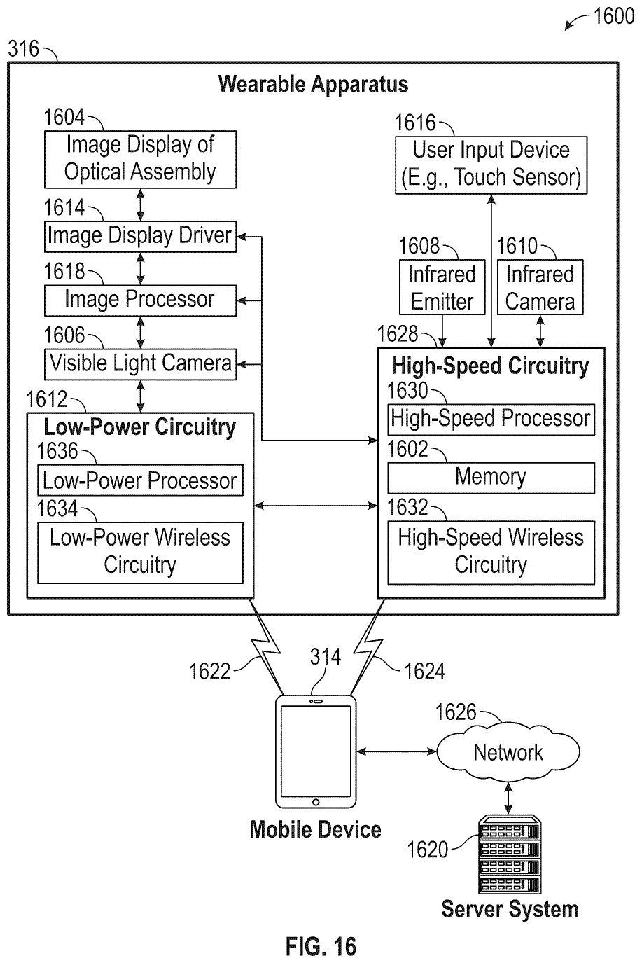

FIG. 16 illustrates a system 1600 including a wearable apparatus 316 with a selector input device, according to some examples. FIG. 16 is a high-level functional block diagram of an example wearable apparatus 316 communicatively coupled to a mobile device 314 and various server systems 1620 (e.g., the server system 310) via various Networks 308.

The wearable apparatus 316 includes one or more cameras, each of which may be, for example, a visible light camera 1606, an infrared emitter 1608, and an infrared camera 1610.

The mobile device 314 connects with wearable apparatus 316 using both a low-power wireless connection 1622 and a high-speed wireless connection 1624. The mobile device 314 is also connected to the server system 1620 and the Network 1626.

The wearable apparatus 316 further includes two image displays of the image display of optical assembly 1604. The two image displays of optical assembly 1604 include one associated with the left lateral side and one associated with the right lateral side of the wearable apparatus 316. The wearable apparatus 316 also includes an image display driver 1614, an image Processor 1618, low-power circuitry 1612, and high-speed circuitry 1628. The image display of optical assembly 1604 is for presenting images and videos, including an image that can include a graphical user interface to a user of the wearable apparatus 316.

The image display driver 1614 commands and controls the image display of optical assembly 1604. The image display driver 1614 may deliver image data directly to the image display of optical assembly 1604 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The wearable apparatus 316 includes a frame and stems (or temples) extending from a lateral side of the frame. The wearable apparatus 316 further includes a user input device 1616 (e.g., touch sensor or push button), including an input surface on the wearable apparatus 316. The user input device 1616 (e.g., touch sensor or push button) is to receive from the user an input selection to manipulate the graphical user interface of the presented image.

The components shown in FIG. 16 for the wearable apparatus 316 are located on one or more circuit boards, for example a PCB or flexible PCB, in the rims or temples. Alternatively, or additionally, the depicted components can be located in the chunks, frames, hinges, or bridge of the wearable apparatus 316. Left and right visible light cameras 1606 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The wearable apparatus 316 includes a memory 1602, which stores instructions to perform a subset, or all the functions described herein. The memory 1602 can also include storage device.

As shown in FIG. 16, the high-speed circuitry 1628 includes a high-speed Processor 1630, a memory 1602, and high-speed wireless circuitry 1632. In some examples, the image display driver 1614 is coupled to the high-speed circuitry 1628 and operated by the high-speed Processor 1630 to drive the left and right image displays of the image display of optical assembly 1604. The high-speed Processor 1630 may be any processor capable of managing high-speed communications and operation of any general computing system needed for the wearable apparatus 316. The high-speed Processor 1630 includes processing resources needed for managing high-speed data transfers on a high-speed wireless connection 1624 to a wireless local area network (WLAN) using the high-speed wireless circuitry 1632. In certain examples, the high-speed Processor 1630 executes an operating system such as a LINUX operating system or other such operating system of the wearable apparatus 316, and the operating system is stored in the memory 1602 for execution. In addition to any other responsibilities, the high-speed Processor 1630 executing a software architecture for the wearable apparatus 316 is used to manage data transfers with high-speed wireless circuitry 1632. In certain examples, the high-speed wireless circuitry 1632 is configured to implement Institute of Electrical and Electronic Engineers (IEEE) 802.11 communication standards, also referred to herein as WI-FIR. In some examples, other high-speed communications standards may be implemented by the high-speed wireless circuitry 1632.

The low-power wireless circuitry 1634 and the high-speed wireless circuitry 1632 of the wearable apparatus 316 can include short-range transceivers (e.g., Bluetooth™, Bluetooth LE, Zigbee, ANT+) and wireless wide, local, or wide area Network transceivers (e.g., cellular or WI-FI®). Mobile device 314, including the transceivers communicating via the low-power wireless connection 1622 and the high-speed wireless connection 1624, may be implemented using details of the architecture of the wearable apparatus 316, as can other elements of the Network 1626.

The memory 1602 includes any storage device capable of storing various data and applications, including, among other things, camera data generated by the left and right visible light cameras 1606, the infrared camera 1610, and the image Processor 1618, as well as images generated for display by the image display driver 1614 on the image displays of the image display of optical assembly 1604. While the memory 1602 is shown as integrated with high-speed circuitry 1628, in some examples, the memory 1602 may be an independent standalone element of the wearable apparatus 316. In certain such examples, electrical routing lines may provide a connection through a chip that includes the high-speed Processor 1630 from the image Processor 1618 or the low-power Processor 1636 to the memory 1602. In some examples, the high-speed Processor 1630 may manage addressing of the memory 1602 such that the low-power Processor 1636 will boot the high-speed Processor 1630 any time that a read or write operation involving memory 1602 is needed.

As shown in FIG. 16, the low-power Processor 1636 or high-speed Processor 1630 of the wearable apparatus 316 can be coupled to the camera (visible light camera 1606, infrared emitter 1608, or infrared camera 1610), the image display driver 1614, the user input device 1616 (e.g., touch sensor or push button), and the memory 1602.

The wearable apparatus 316 is connected to a host computer. For example, the wearable apparatus 316 is paired with the mobile device 314 via the high-speed wireless connection 1624 or connected to the server system 1620 via the Network 1626. The server system 1620 may be one or more computing devices as part of a service or network computing system, for example, which includes a processor, a memory, and network communication interface to communicate over the Network 1626 with the mobile device 314 and the wearable apparatus 316.

The mobile device 314 includes a processor and a Network communication interface coupled to the processor. The Network communication interface allows for communication over the Network 1626, low-power wireless connection 1622, or high-speed wireless connection 1624. Mobile device 314 can further store at least portions of the instructions in the memory of the mobile device 314 memory to implement the functionality described herein.

Output components of the wearable apparatus 316 include visual components, such as a display such as a liquid crystal display (LCD), a plasma display panel (PDP), a light-emitting diode (LED) display, a projector, or a waveguide. The image displays of the optical assembly are driven by the image display driver 1614. The output components of the wearable apparatus 316 further include acoustic components (e.g., speakers), haptic components (e.g., a vibratory motor), other signal generators, and so forth. The input components of the wearable apparatus 316, the mobile device 314, and server system 1620, such as the user input device 1616, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The wearable apparatus 316 may also include additional peripheral device elements. Such peripheral device elements may include sensors and display elements integrated with the wearable apparatus 316. For example, peripheral device elements may include any I/O components including output components, motion components, position components, or any other such elements described herein.

In some examples, the wearable apparatus 316 may include biometric components or sensors s to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like.

Any biometric data collected by the biometric components is captured and stored with only user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1622 and high-speed wireless connection 1624 from the mobile device 314 via the low-power wireless circuitry 1634 or high-speed wireless circuitry 1632.

### Machine 1700

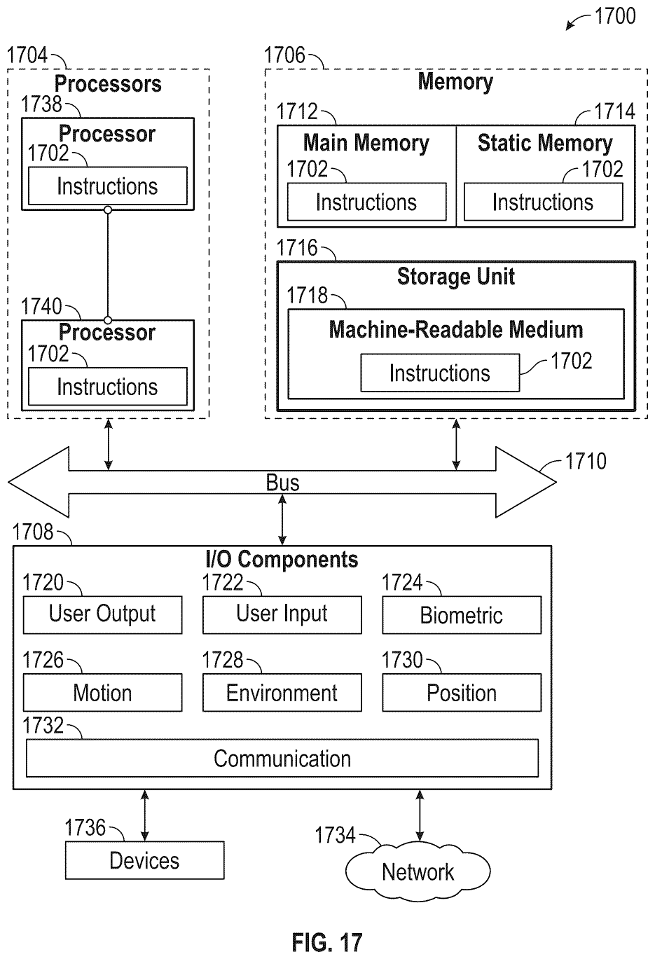

FIG. 17 is a diagrammatic representation of the machine 1700 within which instructions 1702 (e.g., software, a program, an application, an applet, an app, or other executable code) for causing the machine 1700 to perform any one or more of the methodologies discussed herein may be executed. For example, the instructions 1702 may cause the machine 1700 to execute any one or more of the methods described herein. The instructions 1702 transform the general, non-programmed machine 1700 into a particular machine 1700 programmed to carry out the described and illustrated functions in the manner described. The machine 1700 may operate as a standalone device or may be coupled (e.g., networked) to other machines. In a networked deployment, the machine 1700 may operate in the capacity of a server machine or a client machine in a server-client network environment, or as a peer-to-peer (or distributed) network environment. The machine 1700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1702, sequentially or otherwise, that specify actions to be taken by the machine 1700. Further, while a single machine 1700 is illustrated, the term “machine” shall also be taken to include a collection of machines that individually or jointly execute the instructions 1702 to perform any one or more of the methodologies discussed herein. The machine 1700, for example, may comprise the user system 302 or any one of multiple server devices forming part of the server system 310. In some examples, the machine 1700 may also comprise both client and server systems, with certain operations of a particular method or algorithm being performed on the server-side and with certain operations of the method or algorithm being performed on the client-side.

The machine 1700 may include Processors 1704, memory 1706, and input/output I/O components 1708, which may be configured to communicate with each other via a bus 1710.

The memory 1706 includes a main memory 1712, a static memory 1714, and a storage unit 1716, both accessible to the Processors 1704 via the bus 1710. The main memory 1706, the static memory 1714, and storage unit 1716 store the instructions 1702 embodying any one or more of the methodologies or functions described herein. The instructions 1702 may also reside, completely or partially, within the main memory 1712, within the static memory 1714, within machine-readable medium 1718 within the storage unit 1716, within at least one of the Processors 1704 (e.g., within the processor's cache memory), or any suitable combination thereof, during execution thereof by the machine 1700.

The I/O components 1708 may include a wide variety of components to receive input, provide output, produce output, transmit information, exchange information, capture measurements, and so on. The specific I/O components 1708 that are included in a particular machine will depend on the type of machine. For example, portable machines such as mobile phones may include a touch input device or other such input mechanisms, while a headless server machine will likely not include such a touch input device. It will be appreciated that the I/O components 1708 may include many other components that are not shown in FIG. 17. In various examples, the I/O components 1708 may include user output components 1720 and user input components 1722. The user output components 1720 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1722 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1708 may include biometric components 1724, motion components 1726, environmental components 1728, or position components 1730, among a wide array of other components. For example, the biometric components 1724 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like.

Any biometric data collected by the biometric components is captured and stored only with user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1726 include acceleration sensor components (e.g., accelerometer), gravitation sensor components, rotation sensor components (e.g., gyroscope).

The environmental components 1728 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 302 may have a camera system comprising, for example, front cameras on a front surface of the user system 302 and rear cameras on a rear surface of the user system 302. The front cameras may, for example, be used to capture still images and video of a user of the user system 302 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 302 may also include a 360° camera for capturing 360° photographs and videos.

Moreover, the camera system of the user system 302 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 302 may also feature triple, quad, or even penta camera configurations on both the front and rear sides of the user system 302. These multiple cameras systems may include a wide camera, an ultra-wide camera, a telephoto camera, a macro camera, and a depth sensor, for example.

Communication may be implemented using a wide variety of technologies. The I/O components 1708 further include communication components 1732 operable to couple the machine 1700 to a Network 1734 or devices 1736 via respective coupling or connections. For example, the communication components 1732 may include a network interface component or another suitable device to interface with the Network 1734. In further examples, the communication components 1732 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1736 may be another machine or any of a wide variety of peripheral devices (e.g., a peripheral device coupled via a USB).

Moreover, the communication components 1732 may detect identifiers or include components operable to detect identifiers. For example, the communication components 1732 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1732, such as location via Internet Protocol (IP) geolocation, location via Wi-Fi® signal triangulation, location via detecting an NFC beacon signal that may indicate a particular location, and so forth.

The various memories (e.g., main memory 1712, static memory 1714, and memory of the Processors 1704) and storage unit 1716 may store one or more sets of instructions and data structures (e.g., software) embodying or used by any one or more of the methodologies or functions described herein. These instructions (e.g., the instructions 1702), when executed by Processors 1704, cause various operations to implement the disclosed examples.

The instructions 1702 may be transmitted or received over the Network 1734, using a transmission medium, via a network interface device (e.g., a network interface component included in the communication components 1732) and using any one of several well-known transfer protocols (e.g., hypertext transfer protocol (HTTP)). Similarly, the instructions 1702 may be transmitted or received using a transmission medium via a coupling (e.g., a peer-to-peer coupling) to the devices 1736.

### Software Architecture 1804

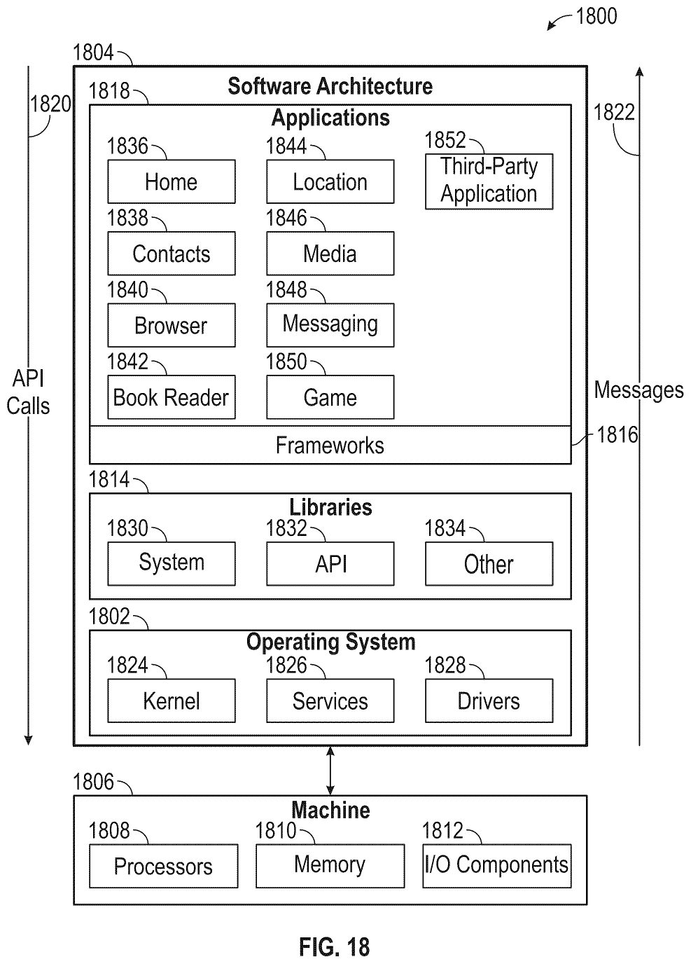

FIG. 18 is a block diagram 1800 illustrating a software architecture 1804, which can be installed on any one or more of the devices described herein. The software architecture 1804 is supported by hardware such as a machine 1806 that includes Processors 1808, memory 1810, and I/O components 1812. In this example, the software architecture 1804 can be conceptualized as a stack of layers, where each layer provides a particular functionality. The software architecture 1804 includes layers such as an operating system 1802, libraries 1814, frameworks 1816, and applications 1818. Operationally, the applications 1818 invoke API calls 1820 through the software stack and receive messages 1822 in response to the API calls 1820.

The operating system 1802 manages hardware resources and provides common services. The operating system 1802 includes, for example, a kernel 1824, services 1826, and drivers 1828. The kernel 1824 acts as an abstraction layer between the hardware and the other software layers. For example, the kernel 1824 provides memory management, processor management (e.g., scheduling), component management, networking, and security settings, among other functionalities. The services 1826 can provide other common services for the other software layers. The drivers 1828 are responsible for controlling or interfacing with the underlying hardware. For instance, the drivers 1828 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1814 provide a common low-level infrastructure used by the applications 1818. The libraries 1814 can include system libraries 1830 (e.g., C standard library) that provide functions such as memory allocation functions, string manipulation functions, mathematical functions, and the like. In addition, the libraries 1814 can include API libraries 1832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1814 can also include a wide variety of other libraries 1834 to provide many other APIs to the applications 1818.

The frameworks 1816 provide a common high-level infrastructure that is used by the applications 1818. For example, the frameworks 1816 provide various graphical user interface (GUI) functions, high-level resource management, and high-level location services. The frameworks 1816 can provide a broad spectrum of other APIs that can be used by the applications 1818, some of which may be specific to a particular operating system or platform.

In an example, the applications 1818 may include a home application 1836, a contacts application 1838, a browser application 1840, a book reader application 1842, a location application 1844, a media application 1846, a messaging application 1848, a game application 1850, and a broad assortment of other applications such as a third-party application 1852. The applications 1818 are programs that execute functions defined in the programs. Various programming languages can be employed to create one or more of the applications 1818, structured in a variety of manners, such as object-oriented programming languages (e.g., Objective-C, Java, or C++) or procedural programming languages (e.g., C or assembly language). In a specific example, the third-party application 1852 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1852 can invoke the API calls 1820 provided by the operating system 1802 to facilitate functionalities described herein.

### Machine-Learning Pipeline 2000

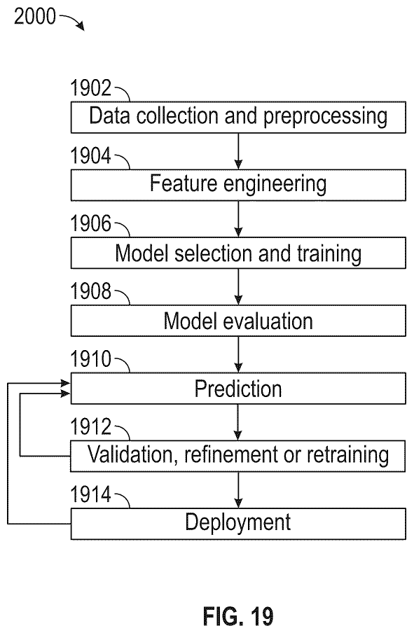

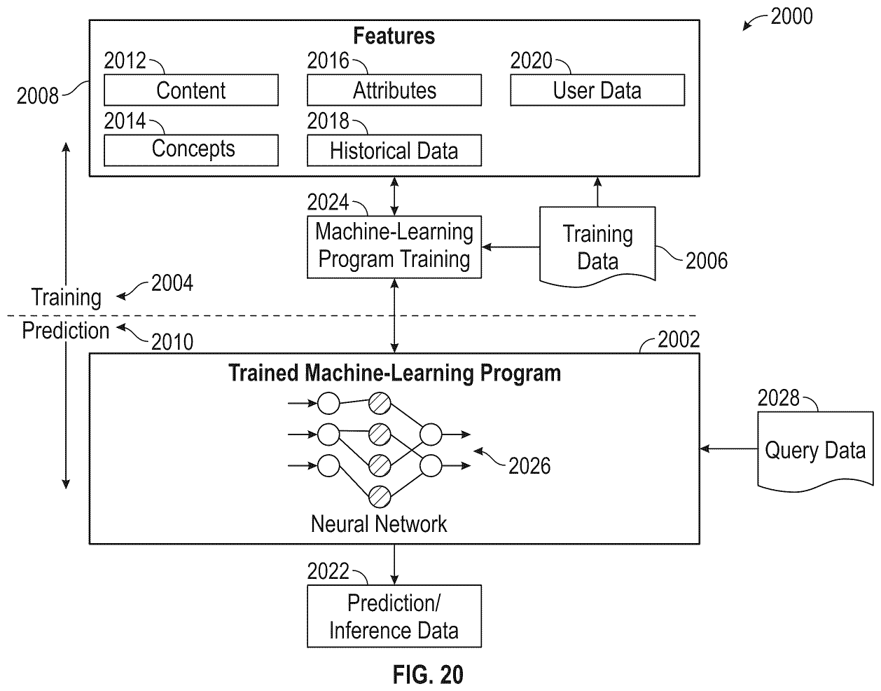

FIG. 19 is a flowchart depicting a machine-learning pipeline 2000, according to some examples. The machine-learning pipeline 2000 may be used to generate a trained model, for example the trained machine-learning program 2002 of FIG. 20, to perform operations associated with searches and query responses. The trained machine-learning program 2002 may be part of the artificial intelligence and machine learning system 424 described above with reference to FIG. 4

### Overview

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting, may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Training Phases 2004

Generating a trained machine-learning program 2002 may include multiple phases that form part of the machine-learning pipeline 2000, including for example the following phases illustrated in FIG. 19:
Data collection and preprocessing 1902: This phase may include acquiring and cleaning data to ensure that it is suitable for use in the machine learning model. This phase may also include removing duplicates, handling missing values, and converting data into a suitable format.
Feature engineering 1904: This phase may include selecting and transforming the training data 2006 to create features that are useful for predicting the target variable. Feature engineering may include (1) receiving features 2008 (e.g., as structured or labeled data in supervised learning) and/or (2) identifying features 2008 (e.g., unstructured or unlabeled data for unsupervised learning) in training data 2006.
Model selection and training 1906: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 1908: This phase may include evaluating the performance of a trained model (e.g., the trained machine-learning program 2002) on a separate testing dataset. This phase can help determine if the model is overfitting or underfitting and determine whether the model is suitable for deployment.
Prediction 1910: This phase involves using a trained model (e.g., trained machine-learning program 2002) to generate predictions on new, unseen data.
Validation, refinement or retraining 1912: This phase may include updating a model based on feedback generated from the prediction phase, such as new data or user feedback.
Deployment 1914: This phase may include integrating the trained model (e.g., the trained machine-learning program 2002) into a more extensive system or application, such as a web service, mobile app, or IoT device. This phase can involve setting up APIs, building a user interface, and ensuring that the model is scalable and can handle large volumes of data.

FIG. 20 illustrates further details of two example phases, namely a training phase 2004 (e.g., part of the model selection and trainings 1906) and a prediction phase 2010 (part of prediction 1910). Prior to the training phase 2004, feature engineering 1904 is used to identify features 2008. This may include identifying informative, discriminating, and independent features for effectively operating the trained machine-learning program 2002 in pattern recognition, classification, and regression. In some examples, the training data 2006 includes labeled data, known for pre-identified features 2008 and one or more outcomes. Each of the features 2008 may be a variable or attribute, such as an individual measurable property of a process, article, system, or phenomenon represented by a data set (e.g., the training data 2006). Features 2008 may also be of different types, such as numeric features, strings, and graphs, and may include one or more of content 2012, concepts 2014, attributes 2016, historical data 2018, and/or user data 2020, merely for example.

In training phase 2004, the machine-learning pipeline 2000 uses the training data 2006 to find correlations among the features 2008 that affect a predicted outcome or prediction/inference data 2022.

With the training data 2006 and the identified features 2008, the trained machine-learning program 2002 is trained during the training phase 2004 during machine-learning program training 2024. The machine-learning program training 2024 appraises values of the features 2008 as they correlate to the training data 2006. The result of the training is the trained machine-learning program 2002 (e.g., a trained or learned model).

Further, the training phase 2004 may involve machine learning, in which the training data 2006 is structured (e.g., labeled during preprocessing operations). The trained machine-learning program 2002 implements a neural network 2026 capable of performing, for example, classification and clustering operations. In other examples, the training phase 2004 may involve deep learning, in which the training data 2006 is unstructured, and the trained machine-learning program 2002 implements a deep neural network 2026 that can perform both feature extraction and classification/clustering operations.

In some examples, a neural network 2026 may be generated during the training phase 2004, and implemented within the trained machine-learning program 2002. The neural network 2026 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 2026 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 2026 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 2004, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 2010, the trained machine-learning program 2002 uses the features 2008 for analyzing query data 2028 to generate inferences, outcomes, or predictions, as examples of a prediction/inference data 2022. For example, during prediction phase 2010, the trained machine-learning program 2002 generates an output. Query data 2028 is provided as an input to the trained machine-learning program 2002, and the trained machine-learning program 2002 generates the prediction/inference data 2022 as output, responsive to receipt of the query data 2028.

In some examples, the trained machine-learning program 2002 may be a generative AI model. Generative AI is a term that may refer to any type of artificial intelligence that can create new content from training data 2006. For example, generative AI can produce text, images, video, audio, code, or synthetic data similar to the original data but not identical.

Some of the Techniques that May be Used in Generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the output prediction/inference data 2022 includes predictions, translations, summaries, or media content.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE STATEMENTS

Example 1 is a method comprising: automatically inferring a location of a user system at a geographic landmark based on location data; triggering an AI assistant based on the inferred location; generating, via the AI assistant, a summary of important information about the geographic landmark; causing display of a graphical indication of the AI-generated summary above a graphical representation of the user on a map interface; and responsive to user selection of the displayed indication, initiating a chat conversation with the AI assistant populated with the generated summary.

In Example 2, the subject matter of Example 1, wherein inferring the user's location comprises using global positioning system (GPS) data.

In Example 3, the subject matter of Example 1, wherein inferring the location of the user system comprises using Wi-Fi triangulation data.

In Example 4, the subject matter of Example 1, wherein inferring the location of the user system comprises using data from multiple sensors of the user system.

In Example 5, the subject matter of Examples 1-4, further comprising adjusting a frequency of updates of the location data based on user activity and context to conserve battery life.

In Example 6, the subject matter of Examples 1-5, wherein triggering the AI assistant is performed responsive to a confidence level of the inferred location transgressing a predetermined threshold.

In Example 7, the subject matter of Examples 1-6, wherein triggering the AI assistant is performed responsive to predetermined historical user activity on the map interface.

In Example 8, the subject matter of Examples 1-7, wherein generating the summary comprises prompting the AI assistant with a query specific to the geographic landmark.

In Example 9, the subject matter of Examples 1-8, wherein the graphical indication comprises an animated transition from a first state to a second state.

In Example 10, the subject matter of Example 9, wherein the first state comprises an icon representing the AI assistant, and the second state comprises the graphical indication including text.

In Example 11, the subject matter of Examples 1-10, further comprising enabling sharing of the AI-generated summary through an interaction platform.

In Example 12, the subject matter of Examples 1-11, further comprising providing the AI-generated summary in multiple selectable languages based on user preferences.

In Example 13, the subject matter of Examples 1-12, further comprising using augmented reality to overlay the AI-generated summary on a display of the user system responsive to a user system camera being directed towards specific features of the geographic landmark.

In Example 14, the subject matter of Examples 1-13, further comprising providing notifications to a user of the user system responsive to the inferring of the location of the user system being at the geographic location.

In Example 15, the subject matter of Examples 1-14, further comprising updating the AI-generated summary based on user interactions and feedback.

In Example 16, the subject matter of Examples 1-15, wherein the geographic landmark comprises a museum, and wherein the AI-generated summary includes information about exhibits within the museum.

Example 17 is a method comprising: automatically inferring a location of a user system at a geographic landmark based on location data; generating, via an AI assistant, a summary of information about the geographic landmark; and causing display of an animated transition of a graphical indication of the AI-generated summary above a graphical representation of the user on a map interface, wherein the animated transition comprises: displaying an initial state showing graphical indication including an icon representing the AI assistant; and transitioning to a final state showing the graphical indication including text of the AI-generated summary.

In Example 18, the subject matter of Example 17, wherein the animated transition comprises a gradual expansion of the icon into a text bubble containing the text of the AI-generated summary.

In Example 19, the subject matter of Examples 17-18, wherein the animated transition is triggered responsive to a user viewing the portion of the map interface containing their graphical representation.

In Example 20, the subject matter of Examples 17-19, further comprising: detecting user interaction with the graphical indication; and in response to the detected interaction, expanding the graphical indication to display additional information from the AI-generated summary.

In Example 21, the subject matter of Example 20, wherein the user interaction comprises at least one of a tap or click on the graphical indication.

In Example 22, the subject matter of Examples 20-21, wherein expanding the graphical indication comprises displaying interactive elements allowing the user to request more specific information about the geographic landmark.

In Example 23, the subject matter of Examples 17-22, further comprising: detecting a user gesture on the map interface; and in response to the detected gesture, scrolling or zooming the map interface while maintaining the relative position of the graphical indication above the user's graphical representation.

In Example 24, the subject matter of Examples 17-23, wherein the graphical indication is selectable to initiate a chat conversation with the AI assistant.

In Example 25, the subject matter of Example 24, wherein initiating the chat conversation comprises transitioning from the map interface to a chat interface pre-populated with the AI-generated summary.

In Example 26, the subject matter of Examples 17-25, further comprising: detecting proximity of the user's graphical representation to multiple geographic landmarks on the map interface; and causing display of multiple graphical indications, each associated with a different geographic landmark.

In Example 27, the subject matter of Example 26, further comprising: detecting user selection of one of the multiple graphical indications; and in response to the selection, prioritizing display of information related to the selected geographic landmark.

In Example 28, the subject matter of Examples 17-27, wherein the graphical indication includes interactive elements allowing the user to at least one of save the AI-generated summary or share it through a social media platform.

In Example 29, the subject matter of Examples 17-28, further comprising: detecting user interaction with specific features or exhibits within the geographic landmark; and updating the graphical indication to display information relevant to the interacted features or exhibits.

In Example 30, the subject matter of Examples 17-29, wherein the graphical indication includes an interactive element allowing the user to provide feedback regarding the AI-generated summary.

In Example 31, the subject matter of Examples 17-30, wherein the graphical indication includes an interactive element allowing the user to switch between different categories of information about the geographic landmark.

Example 32 is a method comprising: receiving, by at least one processor, location data from a user system; analyzing the location data to determine that the user system is located within a predefined geofence corresponding to a specific geographic location; responsive to determining the user system is within the predefined geofence, initiating a further precise location determination process; based on the precise location determination process, confirming the presence of the user system inside the geographic location; and triggering location-based services associated with the specific geographic location responsive to confirming the presence of the user system.

In Example 33, the subject matter of Example 32, wherein the further precise location determination process comprises: collecting data from multiple data sources including at least two of: GPS, Wi-Fi triangulation, Bluetooth beacons, and cellular network data; combining the collected data using sensor fusion techniques to improve location accuracy; and adjusting the frequency of data collection from each source based on an activity state of the user system to conserve battery life.

In Example 34, the subject matter of Example 33, wherein adjusting the frequency of data collection comprises: reducing the frequency of GPS data collection based on the user system being determined to be stationary; and increasing the frequency of GPS data collection based on the user system being determined to be in motion.

In Example 35, the subject matter of Examples 32-34, wherein confirming the presence of the user system inside the specific geographic location comprises: detecting signal obstruction and multipath effects characteristic of indoor environments; and analyzing the signal obstruction and multipath effects to distinguish between outdoor proximity to a building and presence inside a building.

In Example 36, the subject matter of Examples 32-35, further comprising: detecting user activity through accelerometer data; correlating the detected user activity with expected activities within the specific building or site; and using the correlation to increase confidence in the determined presence of the user system inside the specific building or site.

In Example 37, the subject matter of Examples 32-36, wherein the predefined geofence is dynamically adjusted based on historical data of false positive and false negative presence determinations.

Example 38 is a method comprising: receiving, by at least one processor, location data for a user system; determining a confidence level that the user system is located at a geographic landmark based on the location data; monitoring user activity on the user system; determining whether to query an AI assistant for information about the geographic landmark based on at least one of: the determined confidence level transgressing a predetermined threshold, and the monitored user activity meeting predefined activity criteria; and responsive to determining to query the AI assistant, generating a query to the AI assistant for information about the geographic landmark.

In Example 39, the subject matter of Example 38, wherein the location data comprises data from multiple sources including at least two of: GPS, Wi-Fi triangulation, and cellular network data.

In Example 40, the subject matter of Examples 38-39, wherein determining the confidence level comprises: analyzing signal strength and accuracy of the location data; and adjusting the confidence level based on historical accuracy of location determinations for the geographic landmark.

In Example 41, the subject matter of Examples 38-40, wherein the predefined activity criteria comprise the user actively using a map interface on the user system.

In Example 42, the subject matter of Examples 38-41, wherein the predefined activity criteria comprise a determination that the user has historically shown interest in similar geographic landmarks.

In Example 43, the subject matter of Examples 38-42, further comprising: adjusting the predetermined threshold based on available system resources of the user system.

In Example 44, the subject matter of Examples 38-43, further comprising: delaying the query to the AI assistant until network connectivity meets a minimum quality threshold.

In Example 45, the subject matter of Examples 38-44, wherein monitoring user activity comprises: detecting user interaction with the user system; and determining a time elapsed since the last detected user interaction.

In Example 46, the subject matter of Examples 38-45, further comprising: caching previously generated AI assistant responses for the geographic landmark; and retrieving a cached response instead of querying the AI assistant if the cached response is determined to be current.

In Example 47, the subject matter of Examples 38-46, wherein determining whether to query the AI assistant further comprises: analyzing current network conditions; and adjusting the predetermined threshold based on the current network conditions.

In Example 48, the subject matter of Examples 38-47, further comprising: detecting proximity to multiple geographic landmarks; and prioritizing which landmark to query the AI assistant about based on user preferences and historical behavior.

In Example 49, the subject matter of Examples 38-48, wherein the predefined activity criteria comprise the user explicitly requesting information about the geographic landmark.

In Example 50, the subject matter of Examples 38-49, further comprising: monitoring battery level of the user system; and adjusting the frequency of location data collection and AI assistant queries based on the battery level.

In Example 51, the subject matter of Examples 38-50, wherein determining whether to query the AI assistant further comprises: analyzing time of day and day of week; and adjusting the predefined activity criteria based on typical user behavior patterns for the current time and day.

In Example 52, the subject matter of Examples 38-51, further comprising: tracking the duration of the user system's presence at the geographic landmark; and triggering a query to the AI assistant after a predetermined duration threshold is met, regardless of user activity.

Example 53 is a method comprising: receiving, by at least one processor, a response from an AI assistant regarding a geographic landmark; integrating the AI assistant response with an existing map callout framework of a map interface; generating a graphical indication incorporating the AI assistant response; causing display of the graphical indication proximate to a representation of the geographic landmark on the map interface; and responsive to user interaction with the graphical indication, expanding the graphical indication to reveal additional information from the AI assistant response.

In Example 54, the subject matter of Example 53, wherein integrating the AI assistant response with the existing map callout framework comprises: parsing the AI assistant response to extract key information; formatting the extracted key information to fit within predefined size constraints of the map callout framework; and generating the graphical indication based on the formatted key information.

In Example 55, the subject matter of Examples 53-54, wherein the graphical indication is displayed above a user's avatar on the map interface when the user is determined to be at the geographic landmark.

In Example 56, the subject matter of Examples 53-55, further comprising: detecting multiple points of interest in close proximity on the map interface; querying the AI assistant for information about each of the multiple points of interest; and generating multiple graphical indications, each corresponding to a different point of interest.

In Example 57, the subject matter of Example 56, further comprising: determining a display priority for each of the multiple graphical indications based on at least one of: user preferences, historical user behavior, or relevance scores provided by the AI assistant; and displaying the multiple graphical indications according to the determined display priority.

In Example 58, the subject matter of Examples 56-57, wherein displaying the multiple graphical indications comprises: initially displaying a consolidated graphical indication representing the multiple points of interest; and responsive to user interaction with the consolidated graphical indication, expanding the consolidated graphical indication to reveal individual graphical indications for each point of interest.

In Example 59, the subject matter of Examples 53-58, wherein the graphical indication includes interactive elements allowing the user to cycle through different categories of information about the geographic landmark.

In Example 60, the subject matter of Examples 53-59, further comprising: detecting user movement on the map interface; and dynamically updating the displayed graphical indication based on the user's proximity to different geographic landmarks.

In Example 61, the subject matter of Examples 53-60, wherein integrating the AI assistant response with the existing map callout framework comprises: adapting the response to different zoom levels of the map interface, providing varying levels of detail based on the current zoom level.

In Example 62, the subject matter of Examples 53-61, further comprising: caching AI assistant responses for frequently visited geographic landmarks; and retrieving cached responses to reduce latency in displaying graphical indications.

In Example 63, the subject matter of Examples 53-62, wherein the graphical indication includes an option to initiate a chat conversation with the AI assistant for more detailed information about the geographic landmark.

In Example 64, the subject matter of Examples 53-63, further comprising: detecting overlapping graphical indications for multiple points of interest; automatically adjusting the positions of the graphical indications to minimize overlap while maintaining proximity to their respective geographic landmarks.

In Example 65, the subject matter of Examples 53-64, wherein integrating the AI assistant response comprises: analyzing the sentiment and tone of the response; and adjusting the visual design of the graphical indication to reflect the analyzed sentiment and tone.

In Example 66, the subject matter of Examples 53-65, further comprising: monitoring user interactions with the graphical indication; collecting feedback on the usefulness of the displayed information; and using the collected feedback to improve future AI assistant responses and integration with the map callout framework.

In Example 67, the subject matter of Examples 53-66, wherein the graphical indication includes augmented reality elements that can be overlaid on a camera view of the geographic landmark when the user switches to an augmented reality mode.

Example 68 is a method comprising: receiving, by at least one processor, location data from a plurality of user systems across different geographical locations; determining, for each user system, whether the user system is at a geographic landmark; for user systems determined to be at geographic landmarks, queuing requests to an AI assistant for information about the respective geographic landmarks; processing the queued requests using a distributed computing architecture to handle concurrent requests; generating responses for the processed requests; and transmitting the generated responses to the respective user systems.

In Example 69, the subject matter of Example 68, further comprising: implementing a load balancing system to distribute incoming requests across multiple server instances based on current server load and geographical proximity to the requesting user systems.

In Example 70, the subject matter of Examples 68-69, wherein processing the queued requests comprises: prioritizing requests based on factors including user activity levels, subscription status, and time sensitivity of the requested information.

In Example 71, the subject matter of Examples 68-70, further comprising: implementing a caching system to store frequently requested information about popular geographic landmarks; checking the caching system before querying the AI assistant to reduce processing load.

In Example 72, the subject matter of Examples 68-71, further comprising: dynamically allocating computing resources based on real-time demand across different geographical regions.

In Example 73, the subject matter of Examples 68-72, wherein generating responses comprises: utilizing parallel processing techniques to generate multiple responses simultaneously.

In Example 74, the subject matter of Examples 68-73, further comprising: implementing a content delivery network (CDN) to efficiently distribute generated responses to user systems across different geographical locations.

In Example 75, the subject matter of Examples 68-74, further comprising: monitoring system performance metrics in real-time; and automatically scaling computing resources based on the monitored metrics to maintain response times below a predetermined threshold.

Example 76 is a method comprising: generating, via an AI assistant, a summary of information about a geographic landmark; retrieving location data and orientation data from a user system; identifying the geographic landmark based on the location and orientation data; displaying the AI-generated summary in an augmented view on the user system; and updating the displayed summary in real-time to an orientation change of the user system.

In Example 77, the subject matter of Example 76, wherein displaying the AI-generated summary comprises: anchoring the summary to specific visual features of the geographic landmark using computer vision techniques.

In Example 78, the subject matter of Examples 76-77, further comprising: detecting user gestures via the user system; and modifying the display of the summary based on the detected gestures.

In Example 79, the subject matter of Examples 76-78, wherein the user system comprises augmented reality spectacles.

In Example 80, the subject matter of Examples 76-79, further comprising: downloading and storing an on-device AI model on the user system; detecting that the user system is offline; and using the on-device AI model to generate summaries about geographic landmarks when offline.

In Example 81, the subject matter of Examples 76-80, further comprising: using depth-sensing capabilities of the user system to accurately position the summary in three-dimensional space relative to the geographic landmark.

In Example 82, the subject matter of Examples 76-81, wherein the augmented view allows users to interact with virtual objects representing different aspects of the AI-generated summary.

In Example 83, the subject matter of Examples 76-82, further comprising: enabling collaborative experiences where multiple user systems can view and interact with the same AI-generated summaries.

In Example 84, the subject matter of Examples 76-83, further comprising: using the augmented view to visualize historical or future states of the geographic landmark based on the AI-generated summary.

In Example 85, the subject matter of Examples 76-84, further comprising: integrating real-time data feeds to enhance the AI-generated summaries with current information about the geographic landmark.

In Example 86, the subject matter of Examples 76-85, wherein the method adapts the presentation of the AI-generated summary to optimize readability and user experience.

In Example 87, the subject matter of Examples 76-86, wherein the method adjusts the transparency of the displayed summary based on environmental lighting conditions.

In Example 88, the subject matter of Examples 76-87, further comprising: implementing gaze tracking to determine which part of the geographic landmark the user is focusing on and adjusting the displayed summary accordingly.

In Example 89, the subject matter of Examples 76-88, further comprising: providing user controls to customize the display of the AI-generated summary in the augmented view.

In Example 90, the subject matter of Examples 76-89, wherein the augmented view incorporates the AI-generated summary into the user's perception of the real-world environment through the user system.

Example 91 is a computing apparatus comprising: at least one processor; and at least one memory storing instructions that, when executed by the at least processor, configure the apparatus to perform operations comprising: automatically, and using at least one processor, infer a location of user system at a geographic landmark based on location data; trigger an AI assistant based on the inferred location; generate, via the AI assistant, a summary of important information about the geographic landmark; cause display of a graphical indication of the AI-generated summary above a graphical representation of the user on a map interface; and responsive to user selection of the displayed indication, initiate a chat conversation with the AI assistant populated with the generated summary.

Example 92 is a non-transitory computer-readable medium on which computer-executable instructions are stored to implement a method comprising: automatically, and using at least one processor, inferring a location of user system at a geographic landmark based on location data; triggering an AI assistant based on the inferred location; generating, via the AI assistant, a summary of important information about the geographic landmark; causing display of a graphical indication of the AI-generated summary above a graphical representation of the user on a map interface; and responsive to user selection of the displayed indication, initiating a chat conversation with the AI assistant populated with the generated summary.

Example 93 is a computing apparatus including a processor and a memory storing instructions configured such that, when executed in cooperation with controlling the processor, the instructions operate the apparatus to perform a method comprising: automatically inferring a location of a user system at a geographic landmark based on location data; generating, via an AI assistant, a summary of information about the geographic landmark; and causing display of an animated transition of a graphical indication of the AI-generated summary above a graphical representation of the user on a map interface, wherein the animated transition comprises: displaying an initial state showing graphical indication including an icon representing the AI assistant; and transitioning to a final state showing the graphical indication including text of the AI-generated summary.

Example 94 is a non-transitory computer-readable medium on which computer-executable instructions are stored to implement a method comprising: automatically inferring a location of a user system at a geographic landmark based on location data; generating, via an AI assistant, a summary of information about the geographic landmark; and causing display of an animated transition of a graphical indication of the AI-generated summary above a graphical representation of the user on a map interface, wherein the animated transition comprises: displaying an initial state showing graphical indication including an icon representing the AI assistant; and transitioning to a final state showing the graphical indication including text of the AI-generated summary.

Example 95 is a computing apparatus including a processor and a memory storing instructions configured such that, when executed in cooperation with controlling the processor, the instructions operate the apparatus to perform a method comprising: receiving, by at least one processor, location data from a user system; analyzing the location data to determine that the user system is located within a predefined geofence corresponding to a specific geographic location; responsive to determining the user system is within the predefined geofence, initiating a further precise location determination process; based on the precise location determination process, confirming the presence of the user system inside the geographic location; and triggering location-based services associated with the specific geographic location responsive to confirming the presence of the user system.

Example 96 is a non-transitory computer-readable medium on which computer-executable instructions are stored to implement a method comprising: receiving, by at least one processor, location data from a user system; analyzing the location data to determine that the user system is located within a predefined geofence corresponding to a specific geographic location; responsive to determining the user system is within the predefined geofence, initiating a further precise location determination process; based on the precise location determination process, confirming the presence of the user system inside the geographic location; and triggering location-based services associated with the specific geographic location responsive to confirming the presence of the user system.

Example 97 is a computing apparatus including a processor and a memory storing instructions configured such that, when executed in cooperation with controlling the processor, the instructions operate the apparatus to perform a method comprising: receiving, by at least one processor, location data for a user system; determining a confidence level that the user system is located at a geographic landmark based on the location data; monitoring user activity on the user system; determining whether to query an AI assistant for information about the geographic landmark based on at least one of: the determined confidence level transgressing a predetermined threshold, and the monitored user activity meeting predefined activity criteria; and responsive to determining to query the AI assistant, generating a query to the AI assistant for information about the geographic landmark.

Example 98 is a non-transitory computer-readable medium on which computer-executable instructions are stored to implement a method comprising: receiving, by at least one processor, location data for a user system; determining a confidence level that the user system is located at a geographic landmark based on the location data; monitoring user activity on the user system; determining whether to query an AI assistant for information about the geographic landmark based on at least one of: the determined confidence level transgressing a predetermined threshold, and the monitored user activity meeting predefined activity criteria; and responsive to determining to query the AI assistant, generating a query to the AI assistant for information about the geographic landmark.

Example 99 is a computing apparatus including a processor and a memory storing instructions configured such that, when executed in cooperation with controlling the processor, the instructions operate the apparatus to perform a method comprising: receiving, by at least one processor, a response from an AI assistant regarding a geographic landmark; integrating the AI assistant response with an existing map callout framework of a map interface; generating a graphical indication incorporating the AI assistant response; causing display of the graphical indication proximate to a representation of the geographic landmark on the map interface; and responsive to user interaction with the graphical indication, expanding the graphical indication to reveal additional information from the AI assistant response.

Example 100 is a non-transitory computer-readable medium on which computer-executable instructions are stored to implement a method comprising: receiving, by at least one processor, a response from an AI assistant regarding a geographic landmark; integrating the AI assistant response with an existing map callout framework of a map interface; generating a graphical indication incorporating the AI assistant response; causing display of the graphical indication proximate to a representation of the geographic landmark on the map interface; and responsive to user interaction with the graphical indication, expanding the graphical indication to reveal additional information from the AI assistant response.

Example 101 is a computing apparatus including a processor and a memory storing instructions configured such that, when executed in cooperation with controlling the processor, the instructions operate the apparatus to perform a method comprising: generating, via an AI assistant, a summary of information about a geographic landmark; retrieving location data and orientation data from a user system; identifying the geographic landmark based on the location and orientation data; displaying the AI-generated summary in an augmented view on the user system; and updating the displayed summary in real-time to an orientation change of the user system.

Example 102 is a non-transitory computer-readable medium on which computer-executable instructions are stored to implement a method comprising: generating, via an AI assistant, a summary of information about a geographic landmark; retrieving location data and orientation data from a user system; identifying the geographic landmark based on the location and orientation data; displaying the AI-generated summary in an augmented view on the user system; and updating the displayed summary in real-time to an orientation change of the user system.

### TERM EXAMPLES

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hard wired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially Processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VOIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A method comprising:
automatically, and using at least one processor, inferring a location of a user system at a geographic landmark based on location data;
triggering an AI assistant based on the inferred location; generating, via the AI assistant, AI-generated information about the geographic landmark;
causing display of a graphical indication of the AI-generated information proximate to a graphical representation of the user on a map interface; and
responsive to user selection of the graphical indication, initiating a chat conversation with the AI assistant that includes the AI-generated information.

2. The method of claim 1, further comprising: adjusting a frequency of updates of the location data based on user activity or context.

3. The method of claim 1, wherein triggering the AI assistant is performed responsive to a confidence level of the inferred location meeting a predetermined threshold.

4. The method of claim 1, wherein triggering the AI assistant is performed responsive to user activity associated with the map interface.

5. The method of claim 1, wherein generating the information comprises: prompting the AI assistant with a query based on the geographic landmark.

6. The method of claim 1, wherein causing display of the graphical indication comprises:
initiating a transition the display of the graphical indication from a first state to a second state.

7. The method of claim 6, wherein:
the first state comprises an icon representing the AI assistant; and
the second state comprises the graphical indication including text.

8. The method of claim 1, further comprising:
enabling sharing of the AI-generated information through a communication or social platform.

9. The method of claim 1, further comprising:
providing the AI-generated information in a plurality of selectable languages.

10. The method of claim 1, further comprising:
overlaying the AI-generated information on a display of the user system responsive to a user system camera being directed towards a feature of the geographic landmark.

11. The method of claim 1, further comprising:
providing notifications to a user of the user system responsive to the inferring of the location of the user system being at the geographic landmark.

12. The method of claim 1, further comprising:
updating the AI-generated information based on user interactions or feedback.

13. The method of claim 1, wherein:
the geographic landmark comprises a venue; and
the AI-generated information includes data about at least one of a feature or an exhibit within the venue.

14. The method of claim 1, further comprising:
detecting proximity of the graphical representation of the user to a plurality of geographic landmarks on the map interface; and
causing display of a plurality of graphical indications, each associated with a different geographic landmark of the plurality of geographic landmarks.

15. The method of claim 14, further comprising:
detecting user selection of one of the plurality of graphical indications; and
in response to the selection, prioritizing display of further AI-generated information related to the selected geographic landmark.

16. The method of claim 1, wherein the graphical indication includes at least one interactive element allowing the user to perform an action with respect to the AI-generated information.

17. The method of claim 1, further comprising:
detecting user interaction with at least one of a feature or an exhibit within the geographic landmark; and
updating the graphical indication to display information relevant to the at least of one the interacted feature or the exhibit.

18. The method of claim 1, wherein the graphical indication includes an interactive element allowing the user to select between different types or categories of information about the geographic landmark.

19. A computer system comprising: at least one processor;
at least one memory storing instructions that, when executed by the at least one processor, cause the computer system to perform operations comprising:
automatically inferring a location of a user system at a geographic landmark based on location data;
invoking an AI assistant based on the inferred location;
generating, via the AI assistant, AI-generated information about the geographic landmark; cause display of a graphical indication of the AI-generated information in association with a graphical representation of the user on a map interface; and
responsive to user selection of the displayed indication, initiating a chat conversation with the AI assistant populated with the AI-generated information.

20. A non-transitory computer-readable medium on which computer-executable instructions are stored that, when executed by one or more processors, cause a client application to perform operations comprising:
automatically, and using at least one processor, inferring a location of a user system at a geographic landmark based on location data;
invoking an AI assistant based on the inferred location; generating, via the AI assistant, AI-generated information about the geographic landmark;
causing display of a graphical indication of the AI-generated information in an associated manner with a graphical representation of the user on a map interface; and
responsive to user selection of the graphical indication, initiating a chat conversation with the AI assistant using the generated information.
